(19) United States
(12) Patent Application Publication
(10) Pub. No.: US 2015/0066739 A1
(43) Pub. Date: Mar. 5, 2015

(54) ADAPTIVE CREDIT NETWORK

(71) Applicant: SIMPLE VERITY, INC., Seattle, WA (US)

(72) Inventors: Randall W. Lucas, JR., Seattle, WA (US); Michael J. Carreno, Seattle, WA (US)

(21) Appl. No.: 14/464,655

(22) Filed: Aug. 20, 2014

Related U.S. Application Data
(60) Provisional application No. 61/871,797, filed on Aug. 29, 2013.

(51) Int. Cl. G06Q 40/02

(52) U.S. Cl. CPC G06Q 40/025
USPC 705/38

(57) ABSTRACT

Embodiments of the present invention provide a system and method for the use of communications networks and preference information to automate the accumulation, processing, and summarization of business credit data pertaining to one or more subject businesses.

### RELATED APPLICATION

The present application claims the benefit of priority to U.S. Provisional Patent Application No. 61/871,797, filed Aug. 29, 2013, and entitled “Adaptive Credit Network,” the entirety of which is hereby incorporated by reference herein.

### TECHNICAL FIELD

The technical field of the present invention encompasses the discovery, accumulation, creation, analysis, and use of data related to business credit, including trade credit references and transaction history.

### BACKGROUND

### Business Creditors Seek Useful Data to Assess Borrowers

The field of business credit encompasses a variety of practices, tools, and products designed to give creditors a risk assessment of a counterparty (borrower). Creditors may be financial lenders, like banks. Financial lenders provide money with the goal of earning interest. Creditors may also be “trade creditors,” who extend “trade credit terms” to their customers. Trade creditors extend terms as an industry norm or as a negotiation concession in order to win or keep business, generally not with an explicit goal of earning interest. There may also be “hidden” or “implicit” creditor relationships, where a party bears a risk of the counterparty's financial default, but without a formalized repayment agreement (such as in a critical supplier or joint venture relationship). In all cases, creditors seek to know if their counterparty is likely to default on their obligations.

### Very Large Borrowers are Relatively Easy to Assess

When creditors examine borrowers who are very large, such as a Fortune 500 company, a sovereign government, or other large corporate entity, the resources available to creditors are generally widespread, rich, and readily commercially available. Very large borrowers typically have financial statements that are audited or reviewed (and therefore deemed reliable, and can be fruitfully analyzed), and the large quantities being traded justify the employment of analysts to examine the borrowers. Analysts may work for a creditor, or they may be third parties, like Ratings Organizations such as Moody's, Standard & Poor's, or Fitch, who make commercially available the results of their analyses. Very large entities often issue bonds, which trade in an information-rich market and provide an observable auction-based pricing on, among other data, the predicted credit spread. The ready availability of data and of skilled analysts makes very large entities relatively easy to assess for creditworthiness.

### Medium-Sized Borrowers are Somewhat Easy to Assess

When creditors examine medium-sized entities, such as “mid-market” companies of up to $500 M in annual revenue, the picture is more opaque, but there are still many commercially available sources of credit information. These companies are typically privately-held and may not have audited financial statements. They are only rarely rated by third party Ratings Organizations. They issue bonds less frequently and when they do, those bonds are often thinly traded, leading to less observable credit spread data. However, medium-sized entities very often have a history of private creditor relationships with a plurality of banks and financial companies (such as leasing companies and factors), and nearly always have a large network of suppliers who extend trade credit. A traditional business credit bureau prepares a Bureau Credit Report by a process of accumulating and processing “Tradelines” (explained below). Bureau Credit Reports are widely available on medium- to large-sized entities. Bureau Credit Reports are highly efficient and cost-effective compared with analysts, and make medium-sized entities reasonably easy to assess for creditworthiness.

### Tradelines are Aggregated Repayment Experiences

Before we examine small entities, we will explain Tradelines. Beginning in approximately the 1970s, credit bureaus started periodically retrieving from certain creditors their computerized accounts-receivable ageing data. A single borrower's history of repayment experiences at a single creditor is generally called a “Tradeline.” All of a bureau's Tradelines pertaining to a single borrower are aggregated together, perhaps with a variety of other information, such as derogatory public-records filings (“Derogs”) for example bankruptcies to form a Bureau Report, and from that Bureau Credit Report, an algorithmically-generated score can be created. Although other data are included, Tradelines are generally considered the most important part of Bureau Credit Reports as they are produced today.

Tradelines are only contributed when it is worth it to both the contributing creditor and the accepting bureau. A creditor agrees to provide Tradelines to a bureau in exchange for something of value, typically a major discount on a bureau's reports. Bureaus agree to accept Tradelines from a creditor when the substantial expense and trouble of parsing and ingesting the data (which is often in disparate formats) is outweighed by the volume of data (generally, the number of individual Tradelines). This arrangement tends to bias bureau records toward Tradelines from very large creditors. In the perhaps more familiar world of consumer credit, Tradelines are typically from large financial lenders; creditworthy consumers often have several revolving lines of credit (from credit cards, overdraft lines of credit, or store house accounts) and often at least one term debt piece (mortgage, car loan, or student loan). Consumer lenders (such as credit card issuing banks, mortgage lenders or servicers, etc.) generally have accounts open for many thousands of consumers, and are heavy users of consumer credit bureau data, so they are very likely to contribute Tradelines to bureaus.

As a result, a typical consumer has several Tradelines, and about 75% of U.S. adults have enough Tradelines on their consumer report to generate a FICO score, the most familiar consumer credit score. However, in the world of business credit, Tradelines are often from non-financial trade creditors. There are many reasons for this difference, but it suffices for our purposes to note that it exists.

### Small to Medium Business (SMB) Borrowers are Hard to Assess

When creditors examine small to medium business entities (SMBs) for example of under approximately $10 M in annual revenue, the picture is much different from that for either very large or medium-sized entities. SMBs are typically privately held, and therefore their financial statements are almost never routinely audited. Owners of SMBs are often unwilling or unable to provide even un-audited financial statements, and even if they are willing, the dollar amounts involved rarely justify employing an analyst to examine them. SMBs generally do not issue bonds. Generally, the only credit information that is commercially available on SMBs comes from Tradelines.

### Bureaus' Tradeline Coverage is Poor for SMBs

However, many (or even most) SMBs are dramatically under-represented among the Tradelines that are contributed to business credit bureaus for a variety of reasons, many of which are structural and endemic. Many SMBs trade with trading partners who are not. Tradeline contributors (remember that for a creditor to contribute Tradelines, the volumes involved must be worth it for both the creditor and the bureau). The problem is especially acute for SMBs with a strong local or community presence, which SMBs might by design or by necessity trade only with other nearby businesses. Many SMBs are considered “unbankable,” which means that traditional banks will not lend to them. Many banks have a threshold of at least $3-5 M in revenue and 3 years of profitability before they will consider lending; this is partly due to legitimate risk aversion, and partly due to the minimum size of loan a bank must place to justify underwriting and servicing costs. This definition of bankable structurally excludes many SMBs as unbankable. When an SMB is “unbankable,” no bank Tradelines can exist.

As a result, the coverage of SMBs with Bureau Credit Reports derived from Tradelines is quite low. Estimates of the number of “thick files” (where sufficient data to make a judgment are present in the Bureau Credit Report) vary widely, but are uniformly under one million, which leaves at least five million U.S. business establishments, primarily in the SMB category, unrated or under-rated by credit bureaus. Bureau records for those borrowers that are not satisfactorily covered are called “thin-file” or “no-hit” records.

### Trade Credit is Very Important to SMBs

In part due to the relative lack of bank credit for many SMBs, trade credit has a very large role. Estimates from economists suggest that trade credit is 2-3 times the size of traditional bank lending. This is described in Murfin, J. and Njoroge, K. “The Implicit Costs of Trade Credit Borrowing by Large Firms,” Working paper, Feb. 2, 2013. Available online at: http://faculty.som.yale.edu/JustinMufin/papers.html).

### Trade Credit References are Used in Lieu of Bureau Reports

Although many business creditors may prefer to rely upon third-party sources such as Bureau Credit Reports, nonetheless, many creditors either choose not to purchase Bureau Credit Reports or are unable to purchase Bureau Credit Reports for borrowers of interest, due to a lack of coverage for certain borrowers. In lieu of purchasing Bureau Credit Reports, a ubiquitous and time-honored practice, particularly among businesses that serve other businesses (“B2B”), is to ask for “Trade Credit References,” namely, other vendors with whom the borrower has a payment history. The responses from the references to a series of questions about payment history may be used to help the creditor assess the borrower.

Typically, the functional group within a creditor business which carries out the reference checks is an accounts-receivable (AR) department, or, at creditors with trade credit operations large enough to justify the specialization, a credit department. We refer to both here as the “credit function.”

### The Mechanics of Checking References is not Automated

In conducting a check of Trade Credit References, the credit function typically provides a “credit application” form, often via paper, FAX, or electronic (PDF) document. The borrower is expected to provide a variety of identifying, contact, and business information about itself, and is typically prompted for three Trade Credit References. The borrower returns this form, typically again via paper, FAX, or an electronic scanned PDF document. The credit function receives the response, and may cycle back with the borrower one or more times in order to clarify, complete, and correct the information satisfactorily to its policies.

Then, the credit function typically solicits responses from one or more of the Trade Credit References. This is almost always done by phone or FAX, although as of 2013, it is becoming cautiously accepted by credit functions to solicit responses via email. The solicitation is generally presented as coming from the creditor, and the Trade Credit Reference is generally assured that its responses will be held in confidence and not shared by the creditor. The response, if any, is sent to the creditor from the Trade Credit Reference directly without involving the borrower. In general, then, the borrower “throws over the wall” his references, and has little or no Knowledge or control over what happens to any information that is exchanged.

Therefore, today, the process of soliciting credit applications, contacting Trade Credit References, and compiling them into a usable form of ersatz credit report, is usually a non-automated process involving significant human workflow.

### Checking References Imposes Costs with Irregular Incentives

Trade Credit References are generally not obligated in any way to respond to requests; they answer, when they do, as a courtesy. They may do so out of courtesy to the borrower, their customer, although there is often a measure of hesitation since the borrower may be seeking better terms at a competitor. They also do so as a professional courtesy to the creditor, since the functional group answering a reference request is generally also the credit function, and hence they may find themselves reciprocating in the future, Trade Credit. References also tend to provide only a subset of the requested information. The information provided by Trade Credit References has real, financially quantifiable value, but the incentives for Trade Credit References to respond are inconsistent and do not reflect that real value,

### Security and Anti-Fraud are Problems with Trade Credit References

In current practice, a Trade Credit. Reference never has a strong assurance that its customer, the borrower, is in fact the party attempting to open an account with a creditor in the name of the borrower. Identity Theft is a concept well-known for its application to individual persons, but it is also a real problem whereby a fraudster appropriates the good name of a business borrower to obtain and use credit in its name. In such Identify Theft cases where trade credit applies, a Trade Credit Reference may merely go on the good word of the creditor who is requesting information. The Trade Credit Reference in this case may unwittingly aid a fraudster and harm his customer (the true borrower). This may expose the Trade Credit Reference, as well as the creditor (and obviously the borrower) to financial and legal risk.

Another type of fraud involving Trade Credit References is where a fraudster provides collusive or false Trade Credit References to a creditor. The investigative techniques available to the credit function at a creditor are generally limited to cross-referencing the names and telephone numbers of Trade Credit References. However, this is complicated by several factors, including the fact that the credit function at a legitimate Trade Credit Reference often has unlisted contact information (such as a direct FAX line). Collusive references may be legitimate businesses but may be inclined to exaggerate the reputation of the borrower.

### Critical Evaluation of Trade Credit Reference Information is Difficult

Because of the way in which responses from Trade Credit References are gathered, namely, in a manual workflow often involving telephone, FAX, and paper, the response data is often recorded in disparate forms and formats. Rules such as “be suspicious if the business claims an age much older than the oldest reference” are impossible to run in an automatic fashion, because of this data disparity. Therefore, the humans who review Trade Credit Reference responses generally must be trusted to “catch” a huge variety of possible problems or inconsistencies, many of which would be amenable to automated processing if only the data were standardized and captured properly. For comparison, in mortgage processing, Washington Mutual, a major U.S. mortgage lender, previously used a rules engine with approximately 5,000 automated rules that were applied to every single mortgage application. No such rules engine is in common use with respect to manually conducted Trade Credit References.

### BRIEF SUMMARY

Banks, businesses, and other creditors are able to receive detailed and reliable information of the credit worthiness of companies using systems and methods to compile, retrieve, store and provide information about these companies. In one embodiment, systems and methods for a credit network workflow for checking credit references using a specialized algorithm to determine creditworthiness is disclosed.

In another embodiment, systems and methods are disclosed for an inter-business network using reference businesses to provide information on goods or services exchanged, monetary information, and/or information regarding the execution and/or follow-up of a particular transaction.

In another embodiment, systems and methods for token-based provisioning are disclosed to verify legitimate requests for business information related to credit worthiness to increase reliability and participation of businesses within the credit information network.

In another embodiment, systems and methods for adaptive credit questioning techniques are disclosed in which algorithms determine the varying of wording, type and depth of profiling questions asked of businesses based on type of business and creditor preference.

In another embodiment, systems and methods are disclosed for self-policing used to create testable assertions using one or more trusted facts related to a business together with various attributes of the business. These assertions are then used by networks of businesses to build a network of trust between good faith members of the network, and to weed out less reliable potential members.

In another embodiment, systems and methods for creditor feedback algorithms are disclosed that consolidate evaluation information from multiple parties concerning their general perception on how an overall transaction was conducted as an integral part of the transaction process.

In another embodiment, systems and methods for electronic pull-based pre-contacted credit references are disclosed, which are used to provide a verification or a weighting of the likelihood of collusive or fraudulent references.

In another embodiment, subject-controlled privacy in commercial credit systems and related methods are disclosed that provide credit risk evaluation based on the willingness of a business to accept payment to provide business information on itself.

In another embodiment, incentive per-action systems and related methods are disclosed that provide incentives to encourage transaction experience reporting by references for subject businesses.

In another embodiment, event cluster flagging systems and methods are disclosed that evaluate historically based business information, including specialize cluster analysis, to determine creditworthiness.

### BRIEF DESCRIPTION OF THE SEVERAL VIEWS OF THE DRAWINGS

FIG. 1 is an illustration of an embodiment of a process by which a creditor decides to check trade credit references on a borrower.

FIG. 2 illustrates an embodiment of the collection into a database of a plurality of credit reference responses via different modes,

FIG. 3 illustrates one or more embodiments of the imputation of a credit reference responses content in the case where a credit reference declines to provide an explicit response.

FIG. 4 illustrates one embodiment of the creation of a business credit report from a variety of data sources.

FIG. 5 illustrates one or more embodiments of the process of monitoring and alerting subsequent to the initial delivery of a report,

FIG. 6 shows a block diagram illustrating example functional elements of one embodiment of a credit network.

FIG. 7 shows one embodiment of an overview of collecting and processing data using a credit network to produce a credit report,

FIG. 8 is an illustration of one or more embodiments of the creation of preferences relating to relative value, costs, contact methods, and automation procedures, and the use of such preferences to guide whether, when, and how a reference is contacted.

FIG. 9 shows an example of a human-readable report.

FIG. 10 shows one embodiment of a determination of a credit profile using a network process.

FIG. 11 shows a graph representing an example of a network of businesses connected by directed arcs representing the type of relationship between each business in the network, illustrating that a business may have arcs of different types and/or different directionalities.

FIG. 12 shows an example of three businesses with creditor relationships to one another and reciprocal cash flows expected from repayment.

FIG. 13 shows one embodiment of a process whereby the three businesses described in the previous figure are determined to be related to one another, and whereby an adverse credit risk event occurring to one business may result in a transformation of estimated credit risk applying to the other businesses, based upon the relationships within the network.

FIG. 14 shows a before and after example of a score which is adjusted using an exponential decay propagated through the network according to the relationships known to the credit network described in the previous figure.

FIG. 15 is a block diagram of one embodiment of a system for conducting token-based provisioning of business credit references.

FIG. 16 illustrates one or more embodiments of provisioning a credit network via transformation and exchange of tokens among parties where the recipient of the token is a credit reference R.

FIG. 17 illustrates an embodiment of the derivation of a trust measure based on application of a function to the token(s) received.

FIG. 18 shows an example Web user interface displaying a set of questions which was adaptively formed.

FIG. 19 shows a schematic of one embodiment of how adaptive questions may be dynamically displayed.

FIG. 20 illustrates one embodiment of a system that implements the use of a set of preferences in order to determine a dynamic display of adaptive questions.

FIG. 21 illustrates one embodiment of a system that implements the use of input facts to create a testable assertion with an expected result.

FIG. 22 illustrates an example of a workflow involving the presentation of testable assertions and the comparison of responses to expected responses.

FIG. 23 illustrates an example of an evaluation of a response versus an expected response and the use of that evaluation in assessing trust.

FIG. 24 is an example flow chart of feedback from a creditor into a credit network.

FIG. 25 illustrates an example workflow of identifying and mapping a credit reference and retrieving known contact information.

FIG. 26 is an example a Web user interface auto-completing the identification of a credit reference.

FIG. 27 illustrates an embodiment, of the creation and application of a preference set in order to effect a privacy-respecting transformation of credit data.

FIG. 28 illustrates an example of the flow of actions between a party and a bureau in order to reward a desired action with a credit and to redeem the credit.

FIG. 29 illustrates an example of a workflow for processing chronologically-applicable data into a summarization of a chronological trust statement.

FIG. 30 illustrates one or more examples of the use of number line “stacking” to “vote” among various chronologically-applicable data for a trusted output.

FIG. 31 illustrates one embodiment of a process to transform the interpretation of credit reference responses according to an observed performance measure.

FIG. 32 illustrates an example of a workflow of checking trade credit references in the absence of an embodiment of the present invention.

FIG. 33 illustrates an example workflow of checking trade credit references using an embodiment providing subject-controlled privacy in commercial credit, token based provisioning, and electronic pull-based pre contacted credit references.

### DEFINITION

In these descriptions, “bureau” may refer to an independent third party apart from subjects or creditors, or it may refer to a function shared by one or more creditors and not acting as an independent third party.

In these descriptions, “set” encompasses a variety of constructs which may include an ordered set, list, bag, or other construct for identifying zero or more items as part of a collection, which construct may retain an ordinal character.

### DETAILED DESCRIPTION

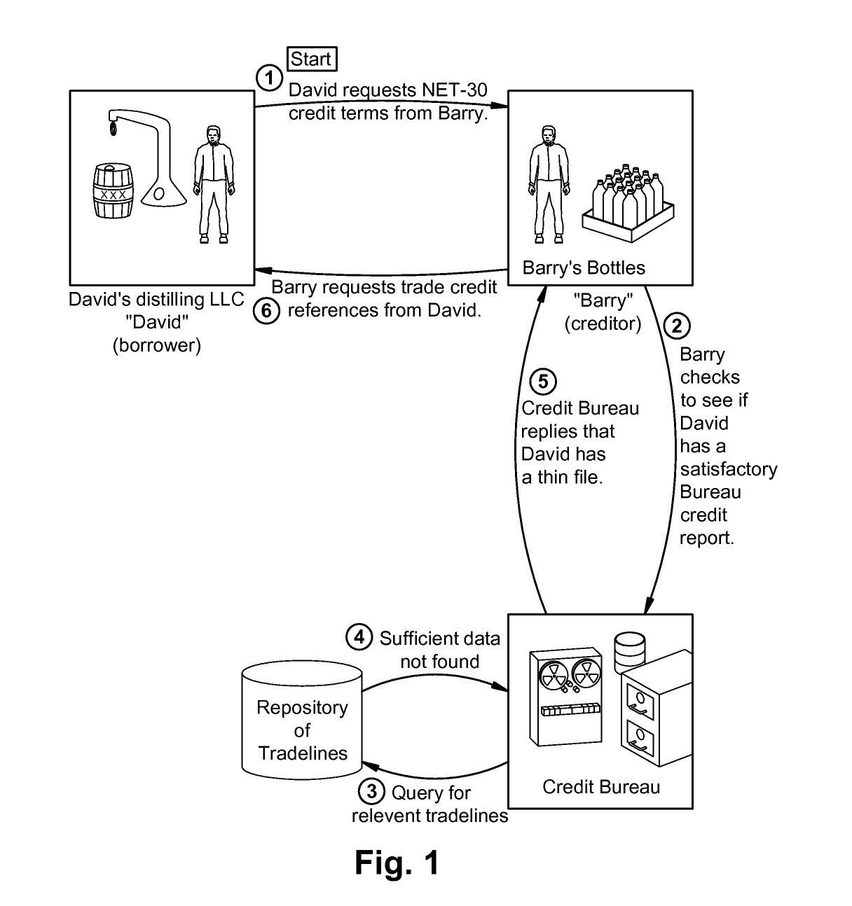

FIG. 1 describes an example where Barry's Bottles (“Barry”) is a manufacturer of custom glass bottles, selling locally in the Seattle area to the thriving marketplace of micro-brewers, micro-distillers, and craft soft-drink manufacturers in the region.

D. D. Stiller is the owner of David's Distilling LLC (“David”), a micro-distillery based in Seattle. For his business, he buys wheat, corn, and bottles, among other raw materials. He would like to purchase bottles from Barry's Bottles, and would like to receive NET-30 credit terms (that is, he'd like to pay 30 days after receiving the materials).

Barry is generally willing to extend NET-30 terms to creditworthy business customers, because it is usual industry practice. Barry's policy is to extend credit to customers with a satisfactory Dun & Bradstreet (credit bureau) rating, or, if no such rating, to customers who present three satisfactory trade credit references. David's Distilling LLC has a “thin-file” record at the credit bureaus, meaning that Dun & Bradstreet, among others, does not give him any rating (including any satisfactory rating).

FIG. 1 shows one embodiment of a process by which Barry decides it necessary to require trade credit references from David. When David applies for credit, Barry checks with a credit bureau such as Dun & Bradstreet, but sees that David has a thin-file. Therefore, Barry requires trade credit references.

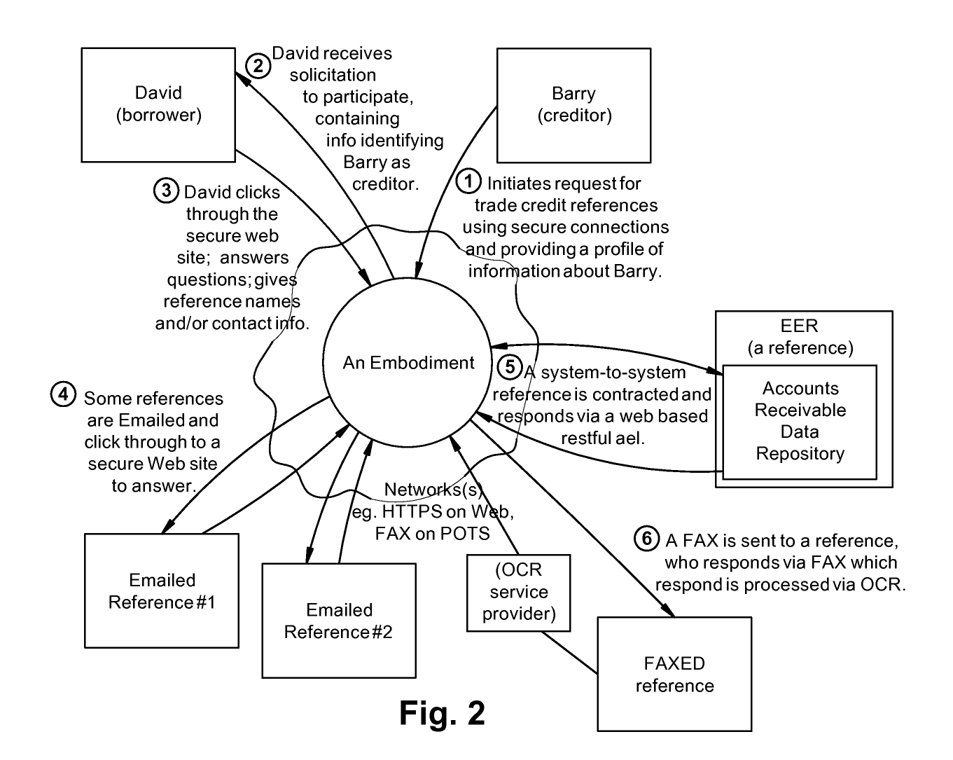

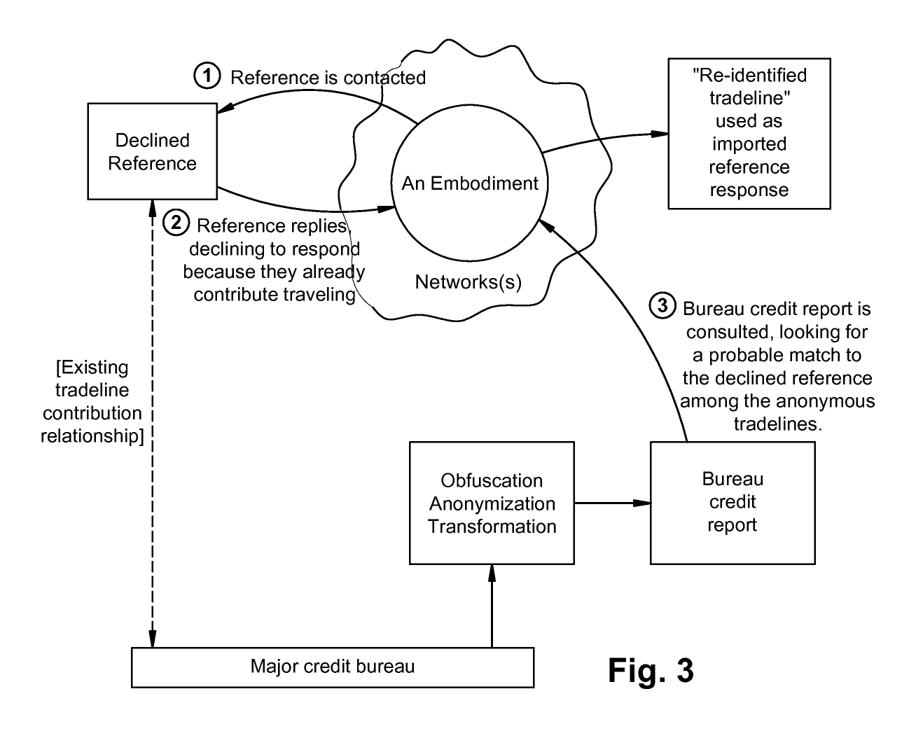

FIG. 2 shows one embodiment of assembling credit data, including trade credit references, via a plurality of methods, from the previous figure. Instead of FAXing a form or emailing a PDF to David, Barry's credit manager instead uses email to direct David's accounts payable (AP) manager to a secure (HTTPS) Web site. That email contains information about David's recent order with Barry, which makes David's AP manager recognize that it is a legitimate request for trade credit references, so the AP manager clicks through.

Once on the site, David's AP manager is asked a variety of questions about the business. David's AP manager answers the questions as best she is able; the system automatically validates her entries in order to minimize typos. She also provides names, and some contact info, for David's trade credit references (other vendors with whom David has established repayment histories) For one of the trade credit references, she started typing the name of an established vendor, Eschew Ergot Ryeberries Inc (“EER”). The name of EER is recognized, then auto-completed, and she does not have to provide contact info for that reference. She also provides certain pieces of information that the trade credit references are likely to recognize as coming from David.

One of the reasons that she is willing to provide this information is that she is given the option to choose who may see which pieces of information; she is therefore reassured that sensitive business information will not leak out. For example, David's may be looking to switch to Barry's Bottles, away from George's Glass, and since the world of micro-distilleries and their local suppliers is small, word of the switch could leak out if all of the references were contacted by Barry directly.

Each of the trade references is contacted automatically; two are reached via email, one via system-to-system communication or API (Application Programming Interface), and one via FAX.

The email-contacted references are each directed to a secure (HTTPS) Web site. They are presented with information derived from David's AP manager's answers, which allows them to be comfortable that they are acting on a legitimate request from David. They answer a variety of questions about their trade experiences, but each reference may be asked a slightly different set of questions, which they don't necessarily notice, because the questions will have been tweaked based upon industry norms as well as the credit policy set up by Barry. They are also asked at least one question which is based upon information provided by David: the answer to that question is to be compared against what David self-reported. One of these references also makes use of the system described in this illustration as a creditor (that is, the reference at other times acts as a creditor and uses the system to check out potential borrowers); that reference receives a credit toward its future use of the system as a “thank-you” incentive for the response.

The system-to-system reference is EER, the reference that was auto-completed for David's AP manager. The system knows how to contact EER, how to automatically provide the identifying information about David's Distilling LLC, and sends it over via a RESTful Web API request. The response contains a pre formed data structure with EE's standard credit reference response data, which the system decodes and treats like any other response.

The FAX-contacted reference receives a FAX with a form that has been dynamically generated to have similar questions to the reference questions presented via HTTPS Web site. The FAX also includes the “legitimate request” reassurance info. This reference answers the questions with a pencil, and returns the page by FAX.

Figure shows an embodiment of a process of imputation of reference response via a bureau tradeline. One additional reference is attempted to be contacted via email, but declines to respond, giving as a reason that it contributes tradelines to a major credit bureau, such as Experian. The system pulls the major bureau's credit report for David the Distiller, and sure enough, there is only one tradeline and it comes from the same ZIP code and industry SIC/NAICS code as the reference who declined. Therefore, the system is able to impute the content of the tradeline in the “thin-file” Major Bureau report as belonging to that reference, and treats it as a reference response.

The reference responses are collected via a Web application, via a FAX to OCR process, via system-to-system API calls, or other means, and put into a database.

A large variety of other external databases have been checked in parallel while these references were being checked. These include checking up on the existence, legitimacy, and contact info of David as well as the references, so as to detect any collusion or fraud (such as an employee of David's attempting surreptitiously to act as a false reference).

A series of processes is applied to the database containing the responses as well as the external database results. These processes include things like checking the information for consistency among respondents. Inconsistent, suspicious, or irregular information is flagged. A report is generated as both a large data structure (which Barry's could choose to import if it used an automatic scorecard, which it doesn't) and as a printable, human-readable report of about two pages in length. The flags are represented as literal colored flag icons on the report. Finally, a couple of different risk indicators are present on the report, giving the credit function inside Barry's a measure both of the likelihood of default and the prudent credit limit to offer David.

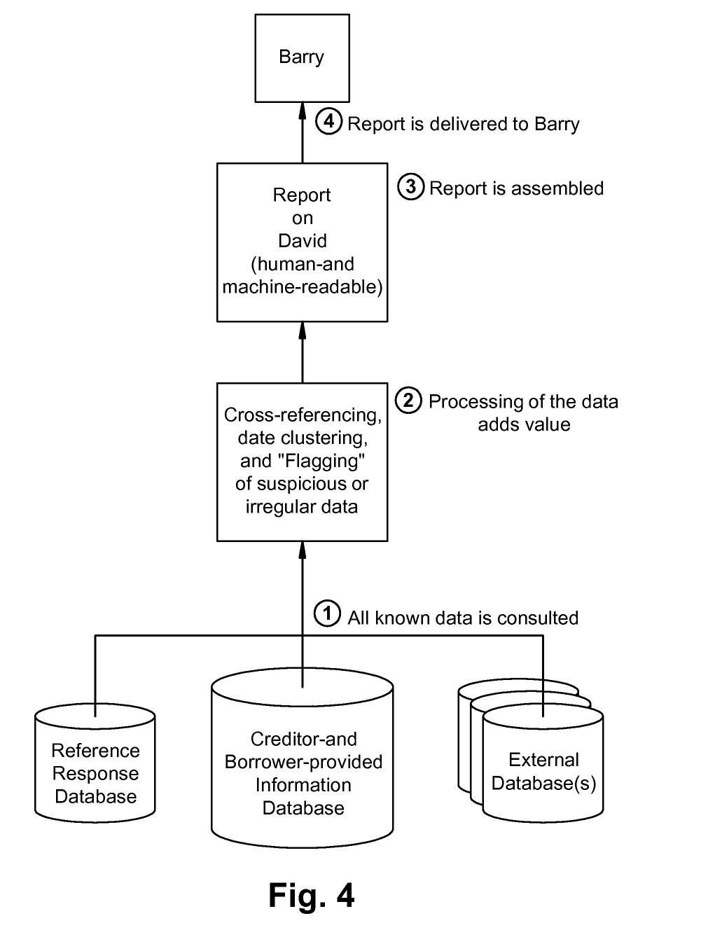

FIG. 4 shows one embodiment of process of assembling, checking, and flagging data from a plurality of data sources in order to create a report. The report also contains an indication that a cluster of dates appears approximately 3.5 years ago in David's history. This cluster includes not only official dates, like dates of incorporation and business license, but unofficial dates such as when the phone number, web site, domain name, and trademarks belonging to David were each last updated. Since David claims to have been in business for 4.0 years, this is not considered a flag and is presented with a low priority. For example, if David had claimed to have been in business for 10 years, a cluster at 3.5 years would have been flagged.

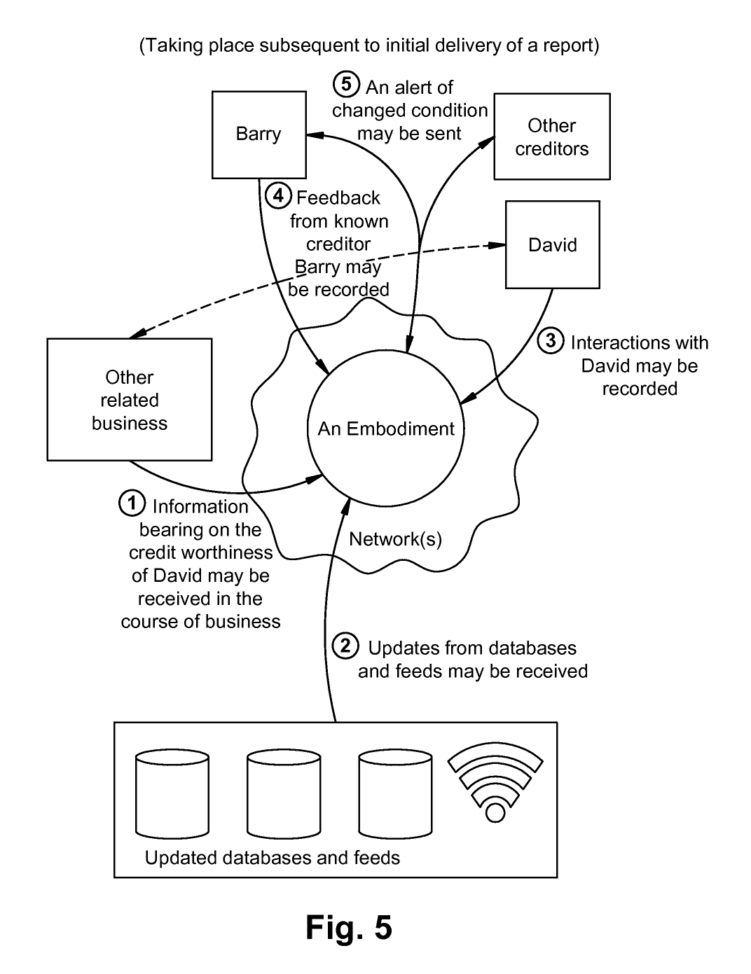

FIG. 5 shows one embodiment of process of monitoring and alerting subsequent to an initial delivery of a report. Barry's credit function examines the report, and takes note of their own internal credit policy. They decide to extend David a $5,000 credit limit. Barry makes a note of this fact within the secure Web site through which the report was delivered, and the system makes note of this fact.

Another vendor doesn't want to bother with conducting credit reference checks or paying a bureau, so he decides to try to search for some free information online. He discovers a website offering “Credit Report on David's Distilling LLC” and clicks on it. The fact of his search and his click are recorded by that website and are fed back into the database of information about David.

Over time, as other participants in the micro-distilling industry cluster ire Seattle buy, sell, borrow, and default amongst one another, more data is built up. The system updates this data and is able to make proactive alerts based upon the propagation through the network of risk information. It is also able to detect abnormal activity, including fraud, by comparison of participants in the cluster to what is expected for their industry, size, and geography. These alerts are delivered via email to creditors like Barry, which allows them to review credit line freeze new shipments, or hasten collections when it becomes prudent so to do.

### Workflow for Checking Business Credit References

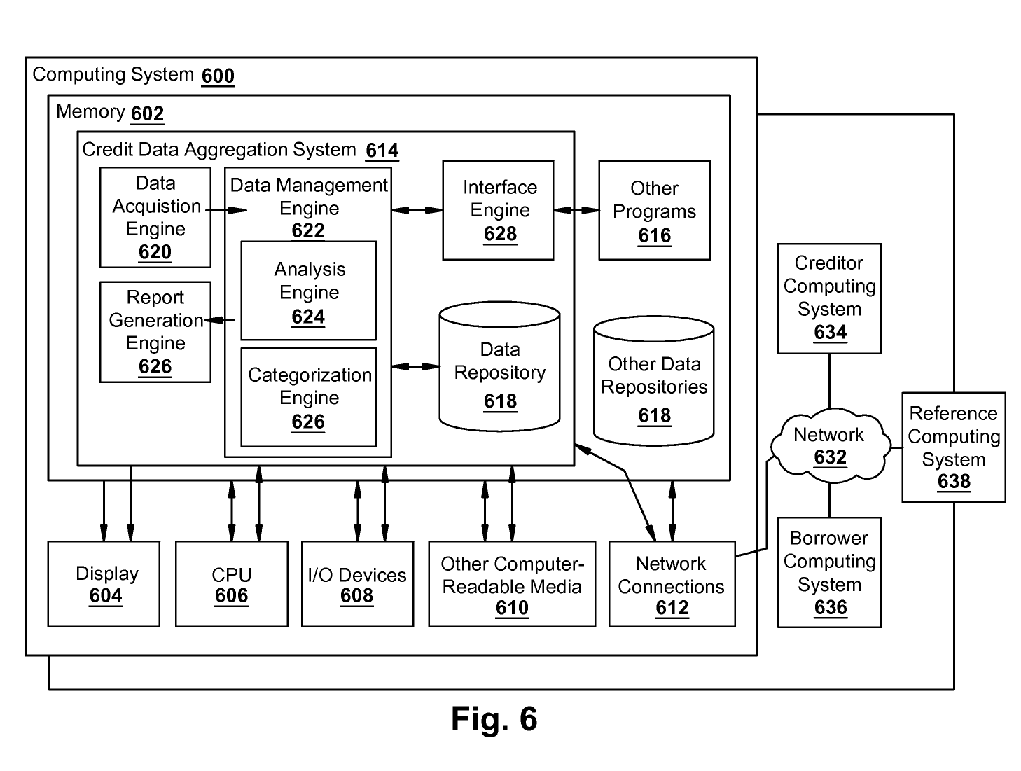

FIG. 6 shows a block diagram illustrating example functional elements of one embodiment of a credit network.

One or more general purpose or special purpose computing systems may be used to implement the computer- and network-based methods, techniques, and systems for the adjustment method described herein and for practicing embodiments of an adjustment system. More specifically, the computing system 600 may comprise one or more distinct computing systems present at distributed locations. In addition, each block shown may represent one or more such blocks as appropriate to a specific embodiment or may be combined with other blocks. Moreover, in one embodiment, the various components of a Credit Data Aggregation System 614 may physically reside on one or more machines, which use standard inter-process communication mechanisms (e.g., TCP/IP) to communicate with each other. Further, an adjustment system may be implemented in software, hardware, firmware, or in some combination to achieve the capabilities described herein.

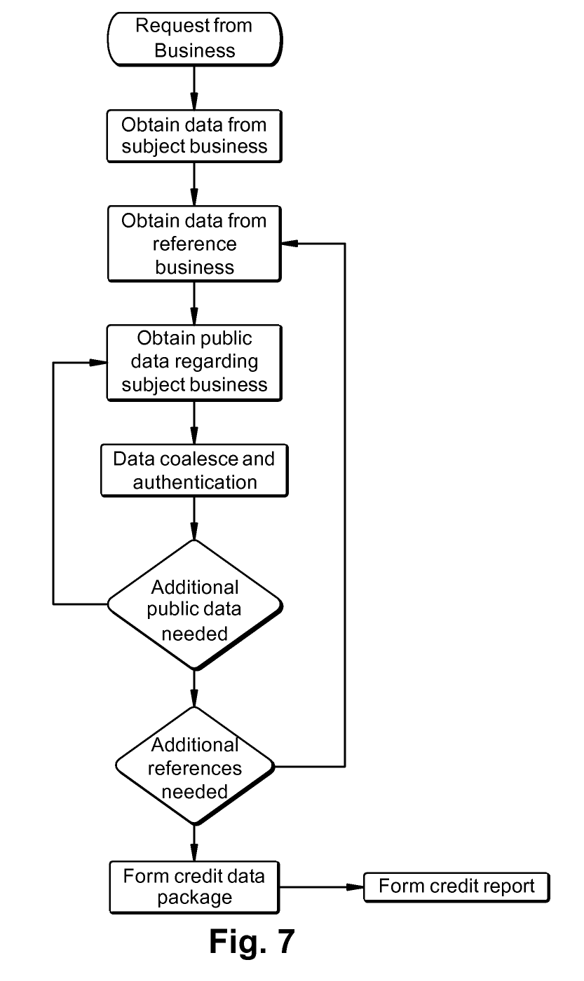

FIG. 7 shows one embodiment of an overview of collecting and processing data using a credit network to produce a credit report. The figure presents one aspect of the process from the perspective of an individual business. A subject business could initially be invited into the system by another business. Data may then be collected from the subject business, possibly including a list of reference businesses. The connection between the inviting business, subject business and reference business are examples of connections within the credit network. Data may also be collected from public sources as one means of augmenting the information in the credit network. Additionally, the above steps may be repeated if it is determined additional references are needed. These added references may have the effect of expanding the network connections for a given subject business. One example result of the set of iterations through this process is a package of credit data, which may be used to form a credit report.

In another example, one or more potential reference businesses R may be identified as potential credit references for a subject business S. Contact information using a communications network to address each R may be solicited from subject S, or may be acquired from other sources. A relative value ranking of the imputed value of reference responses from each R may be generated based upon, among other things, the imputed trustworthiness of R (as perhaps indicated by age, matching to known directories of business entities, etc.), the size of R, or the industry of R (as, for example, in the known tendency of creditors sometimes to prefer references from others in their own industry when evaluating a borrower). A mechanism for ranking preferences as to suitable times and manners for contacting each R may draw upon such factors as cost of a communications medium, the likely business hours of R, the industry practices of R, the known preferences of R, or an imputed statistical likelihood of receiving a useful response from R. A mechanism for contacting R is engaged according to the value ranking and preference ranking. One or more data may be requested from R in relation to subject S in one or more of the messages sent to R. One or more response messages may be expected from R; if received, response messages are processed to transform the response into a computer-readable representation which may relate to a business or credit characteristic of S. If R does not respond after some period of time, a follow-up message may be generated or an alternative form of contact may be chosen based upon the preference ranking.

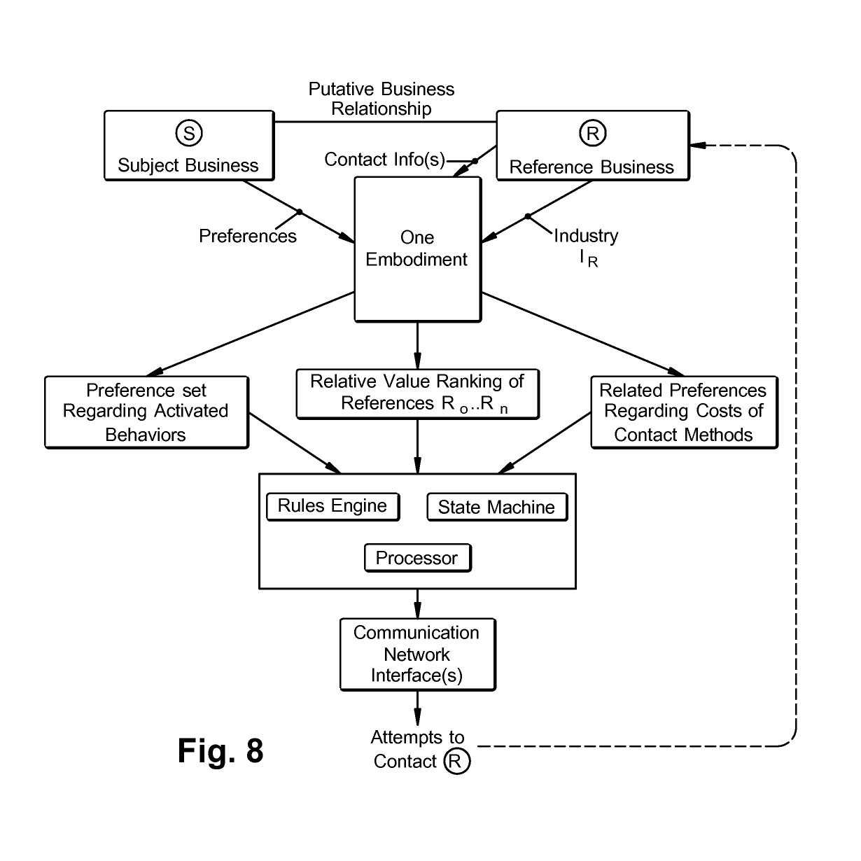

FIG. 8 is an illustration of one or more embodiments of the creation of preferences relating to relative value, costs, contact methods, and automation procedures, and the use of such preferences to guide whether, when, and how a reference is contacted. A set of preferences which may be derived from the preferences of subject S or of a requesting party P may be used to determine further behaviors regarding contacting references, such as the number of times to follow up, or the number of references in total to be contacted to produce a satisfactory output. A rules engine and/or state machine and/or other well-known mechanisms may be utilized to process the derived set of preferences, the relative value ranking, and the preference ranking, and transform them into instructions which effect the contacting of references via a communications network.

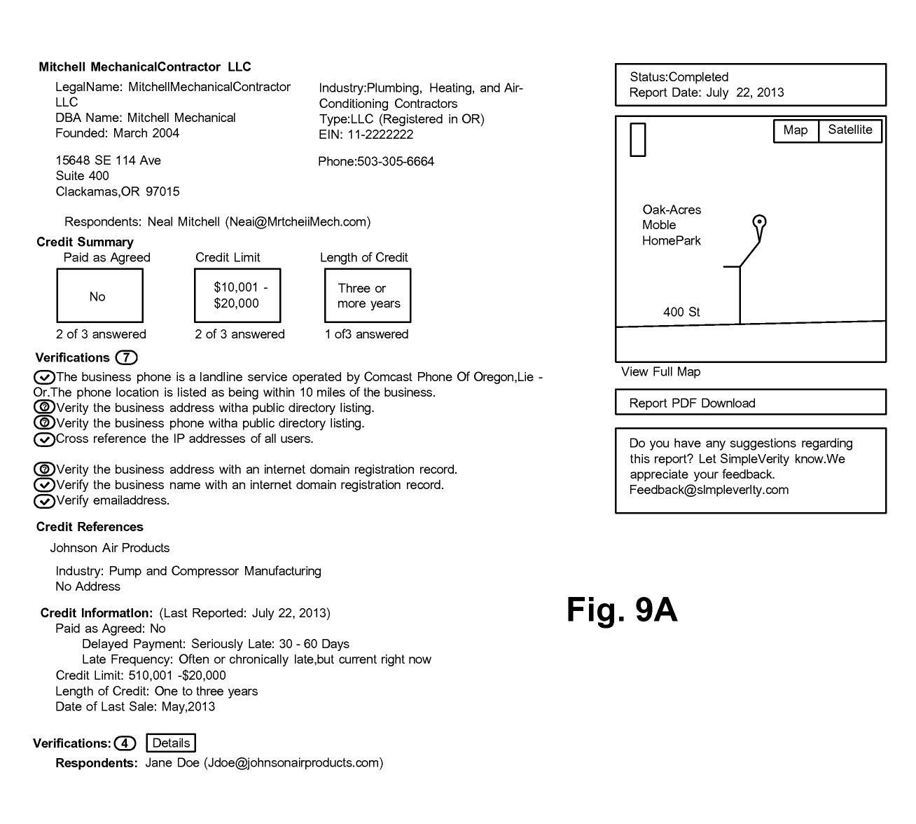

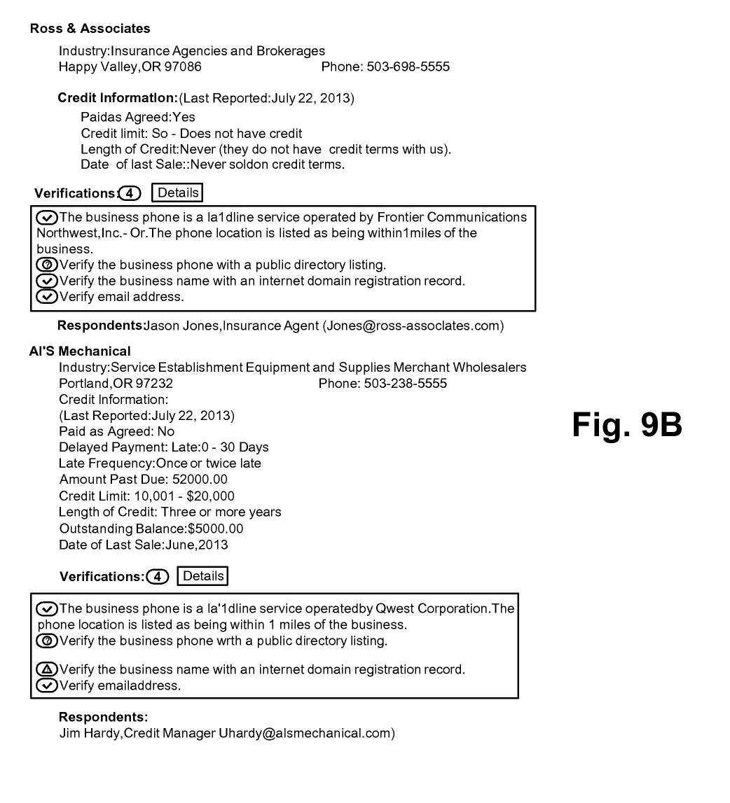

FIG. 9 shows an example of a human-readable report generated using one embodiment based upon responses from credit references. A human-readable report may be produced by a transformation worked upon the data representing the responses from a reference R, and presented to a human decision-maker at party P with an interest in the creditworthiness of subject S. A machine-readable report may be produced by a transformation worked upon the data representing the responses from a reference R and delivered by a network interface to a computing device capable of applying a transformation yielding a value, such as a scorecard, which value may be a scalar value with a statistically or empirically derived meaning, such as a numeric credit score.

Current practice uses very little automation while checking business credit references. One manifestation of the present invention can make intelligent decisions, both cost- and trust-related, about which references to contact and how, and can execute on these decisions. The benefit is that the element of human labor and error can be removed from the rote work of contacting and be applied instead to credit evaluation, which has inherent subjectivity and nuance.

In the foregoing illustrative example, the process whereby Barry requests and ultimately receives credit references on David is an example of one embodiment. The benefits to Barry are speed, cost, and accuracy.

### Network Determination of Credit Report.

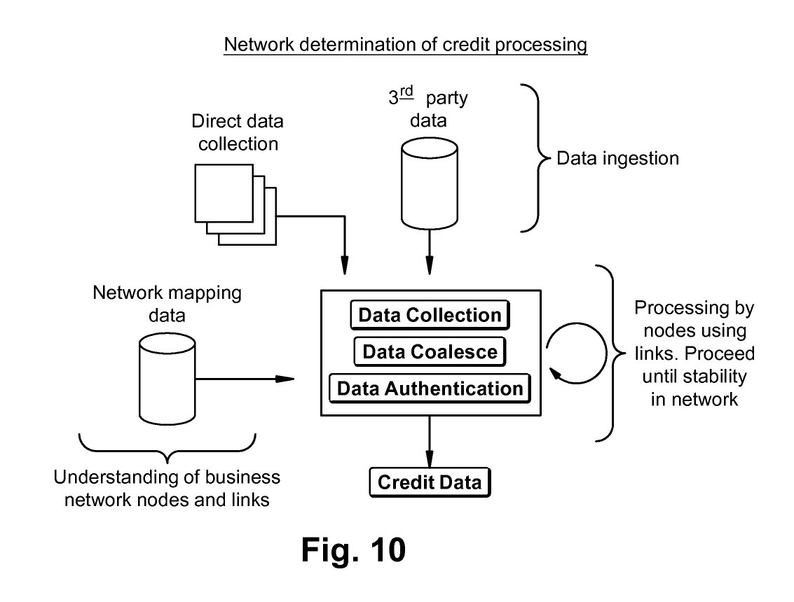

FIG. 10 shows one embodiment of a system for the determination of a credit profile using a network. Data may be collected through a variety of means. This data collection could occur directly from businesses in the system or through the use of 3^{rd} party data sources. A network of businesses may be utilized in the collection of credit data and the formation of a credit report. The data and its various connections and relationships may be retained in a separate data repository. The connections and corresponding network may be represented as a set of nodes possibly connected by arcs where nodes represent individual businesses and arcs represent business relationships occurring between individual businesses in the network. The resulting data could then be coalesced and processed. One means of processing this data is described in FIG. 7.

In another example, a request may be formed for a business S to provide information on their business and the business transactions they share. This request may originate from an external party P such as a creditor C, or the business S itself. Business S may be asked to provide one or more credit reference business that S purports to have had business transactions with in the past. Each reference business Rn may be contacted for information about business Rn and/or business S, along with information about the transactions that occurred between S and Rn.

Various types of information may be gathered regarding the transactions that occurred between S and Rn. This could include the transaction terms, temporal information, information regarding the goods or services exchanged, monetary information, and information regarding the execution and follow-up of the transaction. This information may be used to form credit assessments on both business S and business Rn.

The network of businesses may be expanded. Business Rn may be contacted to obtain a new set of reference businesses that may have had business transactions with Rn. Business Rn would then become Sn with a new set of businesses [R0, R1, . . . Rn] associated with Sn. Similar to above, data may be collected about. Sn, the businesses in the new set, of references, and information about the transactions that occurred between Sn and each business within the set of references.

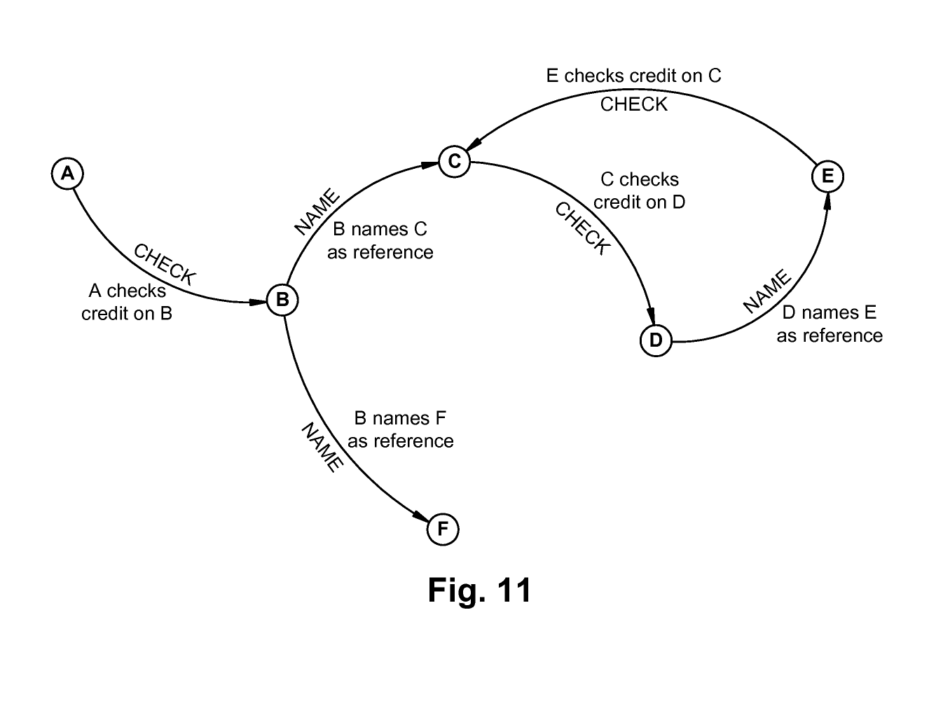

FIG. 11 shows a graph representing an example of a network of businesses connected by directed arcs representing the type of relationship between each business in the network, and illustrating that a business may have arcs of different types and/or different directionalities. A business may appear in multiple nodes within various parts of the network. Another representation may have a business appear as a single node with multiple arcs representing its relationships. A business may act as an interested creditor C, it could be contacted to be a subject business S, or part of a transaction and data collection as a reference business R. Information about these various roles may be gathered with each occurrence of a business in that role.

The information collected through the network of businesses which information may be about a business itself and may be about transactions undertaken by a business may be used to form credit data on a business. Credit data may include assemblies of raw data which bear on creditworthiness, or they may include logically derived implications based on rules (such as “expert rules”), they may include mathematically derived scores or conclusions based on algorithms such as “empirical rules”), or they may include visual or other human representations of some or all of the foregoing. Data from a business and a particular transaction may be used to form a subset of credit data. This data may be combined with previous subsets of credit data associated with the business to form a new set of credit data. The process may continue with each occurrence of the business within a network of businesses and corresponding business transactions.

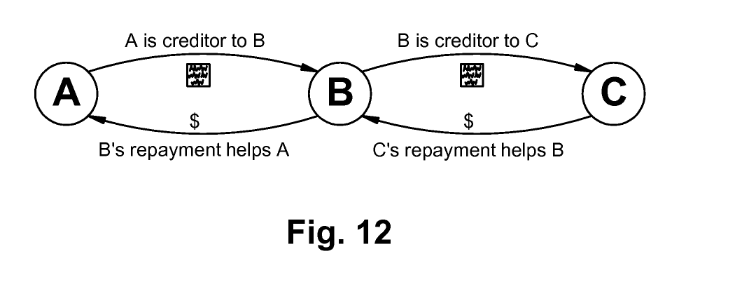

FIG. 12 shows an example of three businesses A, B, and C with creditor relationships to one another and reciprocal cash flows expected from repayment.

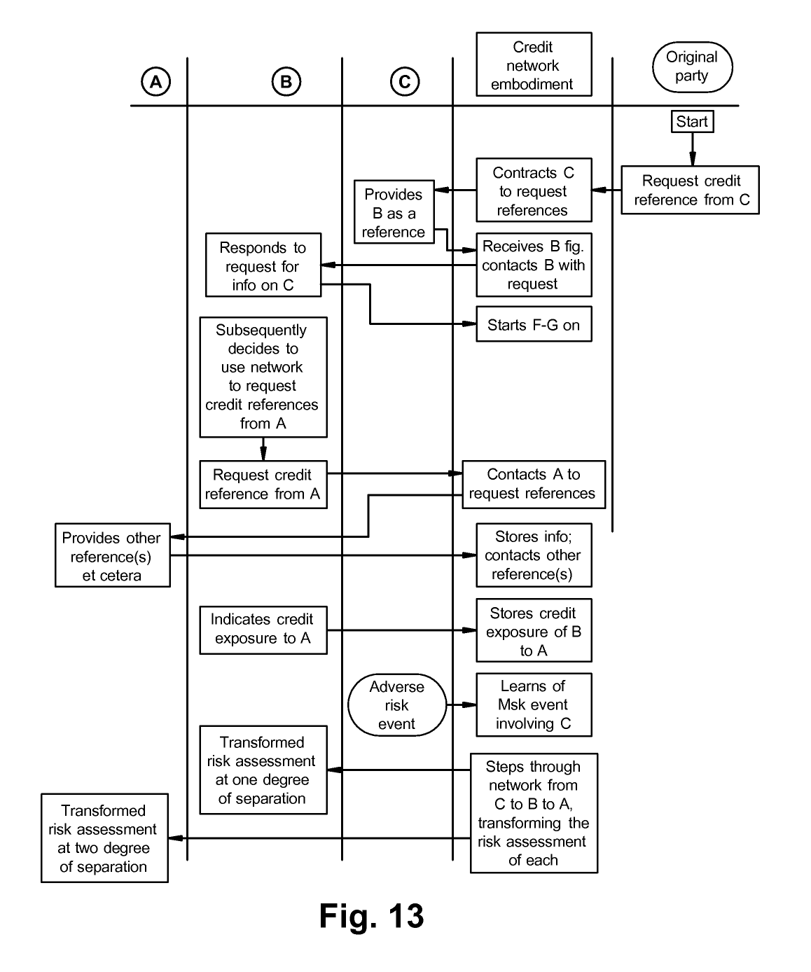

FIG. 13 shows one embodiment of a process whereby the three businesses described in the previous figure are determined to be related to one another, and whereby an adverse credit risk event occurring to one business may result in a transformation of estimated credit risk applying to the other businesses, based upon the relationships within the network.

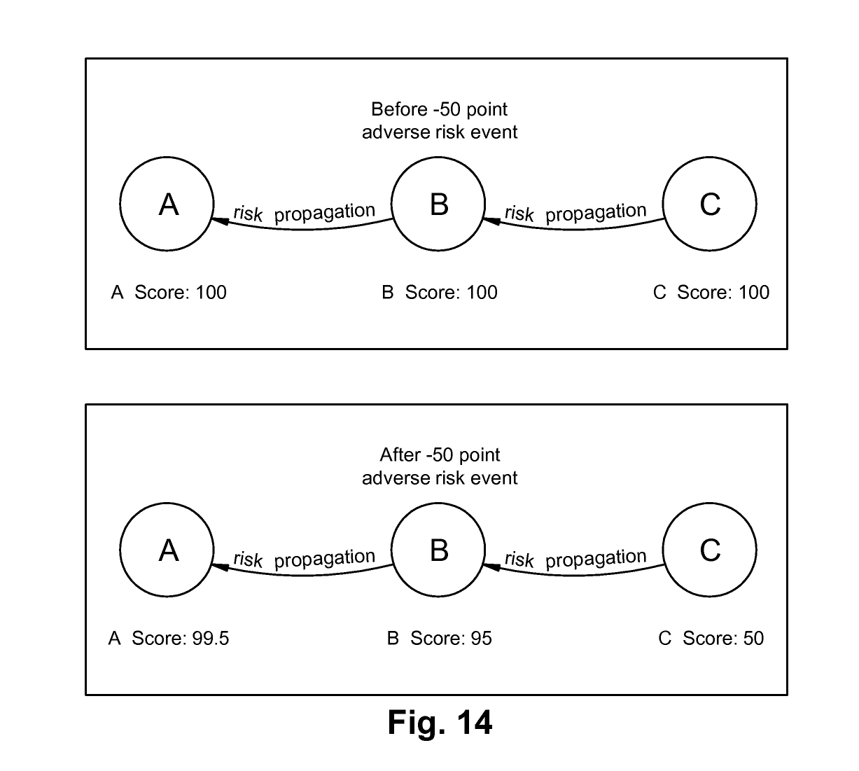

FIG. 14 shows a before and after example of a score which is adjusted using an exponential decay propagated through the network according to the relationships known to the credit network described in the previous figure. The reference relationship between two businesses carries an implicit suggestion of a financial dependency between them such that risk affecting the borrower's ability to repay the creditor must have some affect on the expectation of risk of the creditor's ability, in turn, to repay his own creditors. Measures of the existence, type, and relative and absolute magnitude of those relationships may be used by an embodiment to transform scores which apply to business nodes in a network upon receipt of knowledge of any event affecting the credit risk of any single node by means of a process that (1) applies a decay function which applies a greater effect to the first-degree connected nodes than to second-degree connected nodes, and so on, and (2) transforms a measure of the change in risk expectations associated with an event in a way that may reflect the existence, directionality, magnitude or weighting of an arc and it such as industry, size, and cardinality of nodes from which the change in risk expectations may be propagated.

In another example, one or more sets of credit data may be used to form a credit profile on a business. As an example a business S1 that has transacted business in accordance to terms with business R2, while possibly taking into account information about S and R, may receive a credit profile P1 (good). Another business S2 that transacted with business R2 and may not have adhered to the terms may receive a credit profile P2 (bad). In the case where S1 and 52 are the same business the credit profile may be combined according to a formula F such that the new credit profile for the business is P3 (mixed)=F(P1 (good), P2 (bad)).

Current processes for collecting business credit data generally rely upon a small number of high-record-volume data contributors (very large businesses). Records from these few contributors is accumulated, but generally forms a picture only of relationships where very large businesses extend credit to the subject. One embodiment of the present invention allows gathering of a wider variety of credit data from a more diverse set of creditors, and may also permit the conversion of a subject business into a supplier of useful credit data about its trading partners, permitting the system to break a reliance on very large data contributors.

In the example of Barry and David, Barry as creditor and David as borrower both benefit from the automation which is enabled by network determination of David's creditworthiness. Barry is able to get a more robust and quantitatively sound credit assessment of David than its own credit function could produce internally using manual human workflows. David is able to put its best foot forward and get a reply on its credit terms request more quickly.

### Token-Based-Provisioning

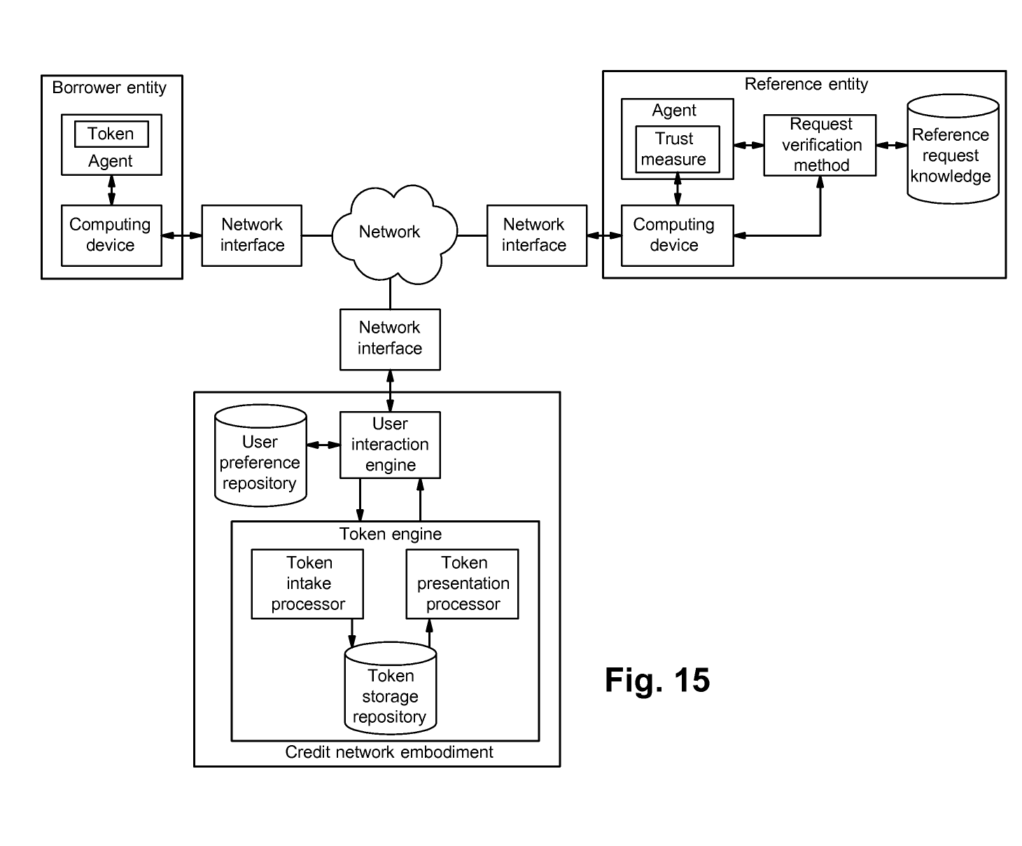

FIG. 15 shows a block diagram of an embodiment of a machine for conducting token-based provisioning of business credit references. A borrower entity, such as a company, may have a responsible agent, such as an accounts payable manager who holds some token which may be physical, knowledge-based, or physically-based (such as biometric), which agent may have an interface to a computing device which is connected to a network via a network interface. A credit network embodiment may have a user interaction engine which may use a set of user preferences applicable to the borrower entity's agent, which preferences are retrieved from a user preference repository, and based upon those preferences may formulate a solicitation for a representation of the borrower entity's agent's token. The user interaction engine may cause to be rendered by the borrower entity's agent's computing device a user interface representing that solicitation, such as a web page with instructions and an HTML form. The borrower entity's agent may use that user interface to enter a representation of that token, such as a password, cryptographic key, an idiosyncratic message, a photograph, or a signature. The user interface as rendered may transmit the representation of the token back to the user interaction engine, which may transform it using a token intake processor, into a form suitable for stability, security, and reusability, and store the transformed representation of the token, such as by encrypting a plaintext password. A token presentation processor may retrieve this transformed representation and further transform it into a testable token representation, such as by using a cryptographic key to sign a message authentication digest, or by embedding a photograph or signature in a page. A reference entity, such as a company who is a creditor to the borrower entity and has a conditional policy willingness to provide reference information on the borrower's credit, may have a responsible agent, such as an accounts receivable manager, who maintains a implicit or explicit trust measure with respect to a request for credit reference information, and who has access to some request verification method, which may depend upon knowledge in a repository of reference request knowledge. The user interaction engine may cause to be rendered by a reference entity's agent % computing device a user interface representing that testable token representation. The reference entity's agent may use that user interface to retrieve the testable token representation and then provide the testable token representation to the request verification method, or alternatively, the reference entity's agent's computing device may provide the testable token representation directly to the in the course of rendering its user interface to the agent. The responds with a modification to the trust measure, which modification is communicated to the agent directly or via a user interface on the computing device. The reference entity's agent may adjust its trust measure with respect to the credit reference information request regarding the borrower entity in the manner suggested by the. The request verification method may consult a repository of reference request knowledge which permits the relative authentication of the testable token representation as having been derived from the borrower entity's agent's token, which knowledge may be, for example, a repository such as a list of customer account numbers, or in another example may be a public-key infrastructure cryptosystem with putative knowledge of the borrower entity's agent's public key.

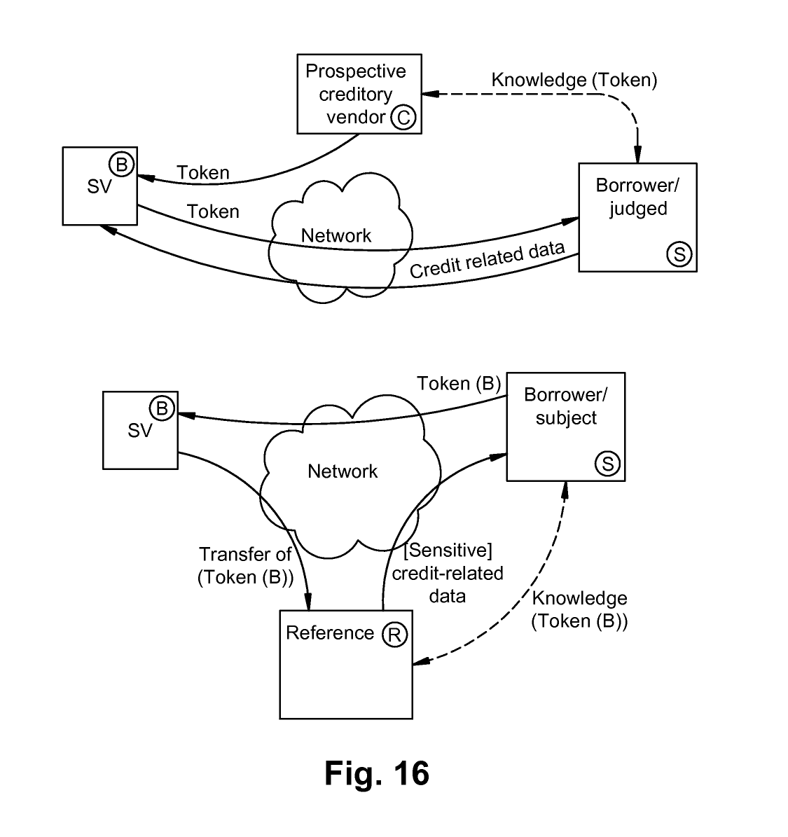

FIG. 16 illustrates one or more embodiments of provisioning a credit network via transformation and exchange of tokens among parties where the recipient, of the token is a credit reference R. A creditor C may request credit data on a subject S from a bureau B. C may provide a piece of information, a token T(c), which indicates that C has made the bona-fide request of B for credit data on S.

A subject S may provide to a bureau B data such as self-reported credit information, and/or the identity and contact info for a reference R. S may provide some additional piece of information, a token T(s), which indicates that S consents to the collection and reporting of data about S by B, and/or requests that R should provide otherwise-confidential trade or credit information to B.

B may have its own token T(b) which indicates the legitimacy of a request from B according to its own reputation and policies. B may transform T(c) and/or T(s) and/or T(b) and/or additional data into a token T, including a concatenation or co-presentation of tokens in a form that may be human-readable, or including only a subset of tokens, or by applying a cryptographic function to one or more tokens along with additional data, such as by using a message authentication algorithm to “sign” a request message.

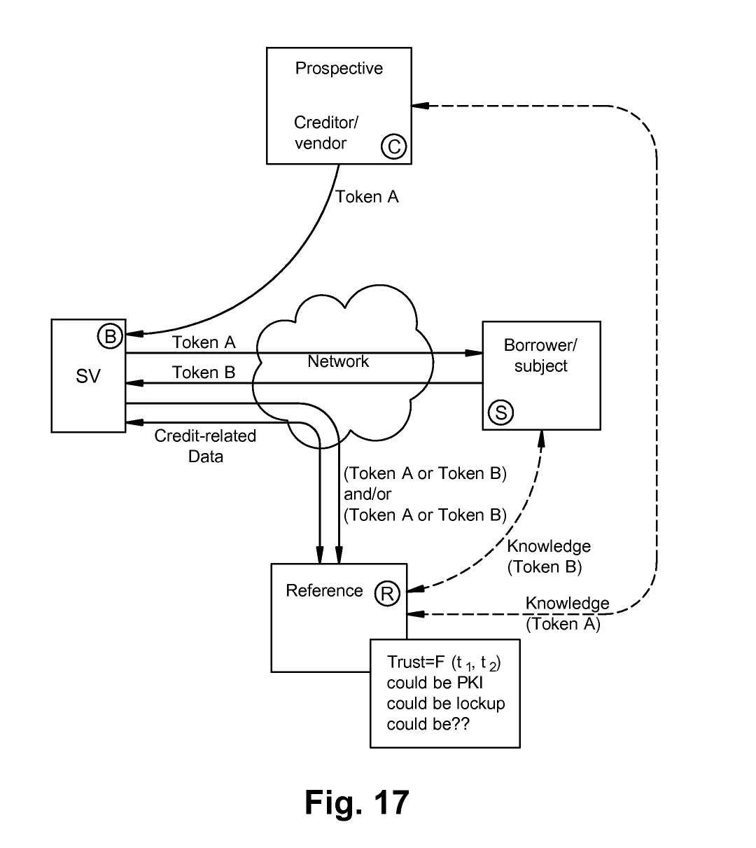

FIG. 17 illustrates an embodiment of the derivation of a trust measure based on application of a function to the token(s) received. Bureau B, which is also identified in the figure as SV, may then present a request for trade or credit information request, along with the transformed token T, to recipient X. X may have a function F(v) which applied to T produces an trust measure likely to influence the willingness of X to respond to the request, including by human judgment of a human-readable T such as recognizing the name and email address of S or C, or by cryptographic verification of the authenticity of a message signature, or by the reflection in T of shared knowledge between X and another party (such as a customer account number).

X may then cooperate in providing or enabling the collection and use of trade or credit information with a higher likelihood than if the transformed token T had not been supplied to X.

For example, recipient X in the above description may be a subject S, which by examination of the token T may receive a verification indication of the authenticity of the original request from creditor C. Alternatively, recipient X in the above description may be a reference R, which by examination of the token T may receive a verification indication of the authenticity of the consent to reporting by subject S. Alternatively, recipient X in the above description may be a creditor C, which by examination of the token T may receive a verification indication of the role of bureau B in processing, authenticating, verifying, or otherwise adding value to the credit data supplied by one or more of S and R.

In another example, a bureau B may receive a higher response and/or completion rate from reference R if token T is supplied to R.

An impostor bureau B(bad) or an impostor subject S(bad) may also be thwarted if during the process, input tokens T(s(bad)) or T(b(bad)) are used to form a transformed token T(bad), and legitimate reference R applies function F(v), producing a negative or suspicious verification indication, including if an improper name or email address is supplied, or if a cryptographic key is untrusted or has been revoked or repudiated.

Trade credit, reference checks are typically conducted directly by a creditor C, or indirectly by a bureau B. C would conduct a check for its own usage, while B would store the content of the check for later use by other creditors. C typically induces R to answer because of an implied request by S, but also due to professional courtesy (C and R are often in the same industry) and because R's request about S “leaks” information to R which is useful to R (i.e. the fact that R's customer S is now seeking to purchase from C, who may be a competitor or substitute). B typically induces R to answer because of other reasons, namely, B may provide a discount on its pricing to R, but typically makes no claim to the consent of S. In neither traditional case is R responding to a well-authenticated request from its customer, S. The TBP invention induces R to respond because R is more confident, due (in addition to other reasons) to the token, that S consents. Current practice neglects any form of cryptographic signing (such as message authentication) for the vast majority of credit data transactions, despite the use of transport-layer security or symmetric document encryption, but an embodiment of the present invention enables such signing and its benefits.

In the foregoing illustrative example, token-based provisioning appears in several places. The original request to borrower David contains token(s) recognized by David's AP manager as likely originating with Barry, embodying an application of a verification function by her, the (positive) result of which increases her trust and willingness to complete the credit reference process. The email-contacted, system-to-system, and FAX-contacted references also are presented with tokens which they evaluate and which help persuade them to participate in the reference process. In the case of the system-to-system reference, the token verification process may be more explicit and more recognizably cryptographically sound, but token-based provisioning applies in all those cases.

### Adaptive Credit Questions

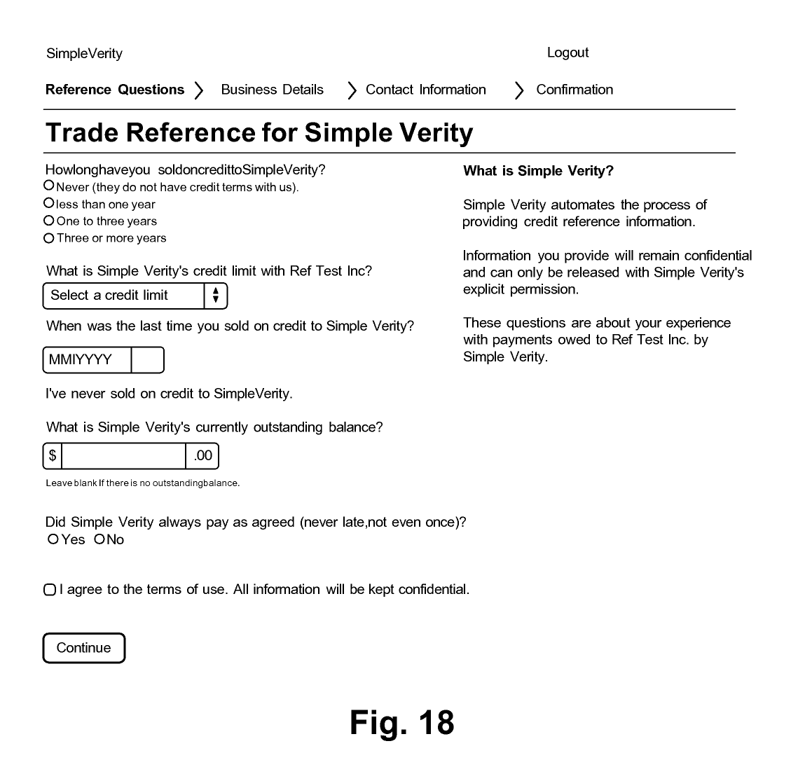

FIG. 18 shows an example bleb user interface d playing a set of questions which was adaptively formed.

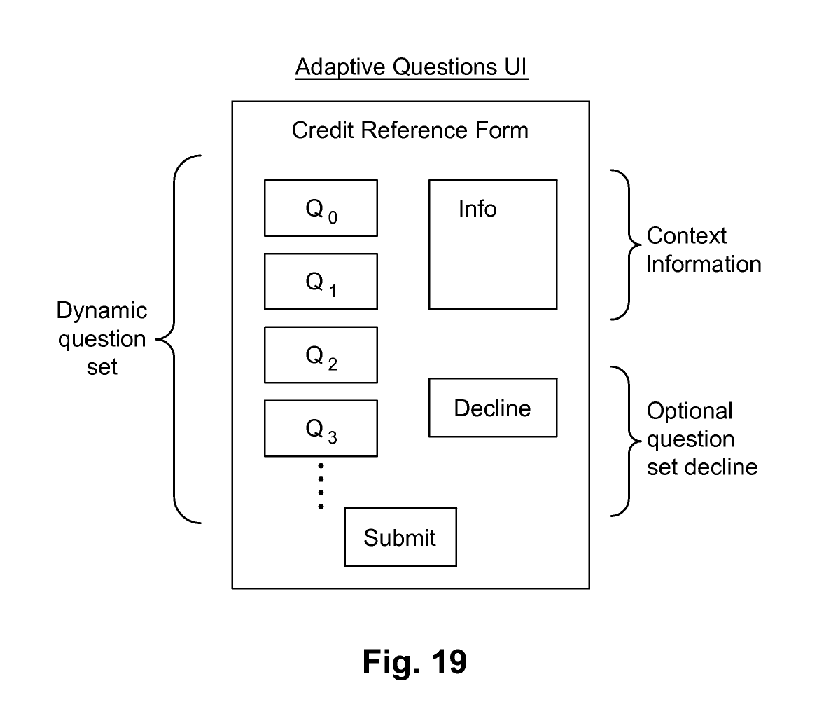

FIG. 19 illustrates a schematic of one embodiment of how components underlying the user interface in the previous figure may be altered.

Information about a subject S and possibly including credit data associated with S may be used to form a set of questions S0 to elicit further information about the business possibly including additional credit information. The additional information may then be used to adjust or adapt question set S0 to form a new set of questions S1. This new question set S1 may be formed with the goal to elicit new information about subject S regarding the business itself or in regards to its credit profile as a means to refine the credit data and credit, profile of subject S. Adjusting or adapting the questions may yield a more efficient means of obtaining a credit profile on subject S over a more simple method of obtaining data through a static set of questions.

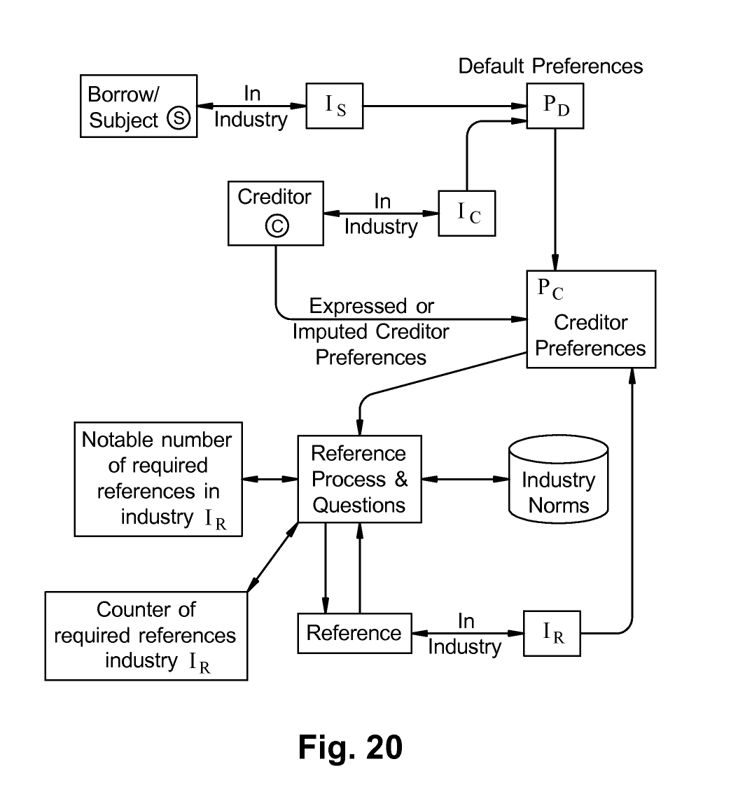

FIG. 20 illustrates one embodiment of a system that implements the consultation of a set of default and industry-specific preferences based upon the industries of the subject S, creditor C, and reference R in order to define the question set presented to the reference R. Each set of questions may be associated with a subject S and with a particular reference R. In this manner different references contributing information about subject S may encounter different sets of questions when determining information about the business and the business' credit information. The questions and question sets may differ in wording, data obtained, order displayed and, when the question was presented to the business.

Each set of questions may also be associated with the preferences of a creditor C who has requested a credit report on subject S. The creditor may specify a preference in the form, “I want to know datum X only when a reference is from industry I” for example, which would result in different sets of questions being presented to references from different industries. A repository of preferences, including default preferences which may be industry-specific based upon the creditor C, subject S, and reference R, may be made available for consultation when choosing which questions to present.

A repository of questions may be defined with each question Qn setup to determine a piece of data Dn. The piece of data may have a relation to a business, business transaction or other piece of data related to a business and their credit information.

An initial set of questions may be formed to elicit data from a business. This set S0 may be formed based on business specific data, industry data or selected based on criteria meant to obtain initial information if no data about the business or industry is currently available. The set of data obtained from question set S0, D(S0), may then be used to form a new set of question for subject S with the goal of obtaining new information about the subject S according to a formula F, so that S1 may equal F(D(S0)).

Current practice does differentiate among credit characteristics of different industries, but it generally does so by using different thresholds or formulae as applied to the same metrics or input data. For example, the Altman-Z score has variants for manufacturing, non-manufacturing, and financial companies, but it is based upon much of the same financial data (rather than industry-specific questions). For another example, the D&B “PAYDEX” score or Experian “Intelliscore” may be compared as to industry averages, but there is not an industry-specific score provided based upon differing, industry-specific underlying data. Efficient application of industry-specific preferences to the credit reference data collection process as enabled by one embodiment of the present invention can help create credit assessments more suitable to the industry characteristics of the parties involved.

In the example of Barry and David, the rendering of the Web-based user interfaces to the email-contacted references, and the dynamic generation of the form sent to the FAX-contacted reference are examples of the dynamic creation of a set of questions. The effect in the example is to most efficiently gain necessary information from references while not burdening them with unnecessary questions (which would lower response rates).

### Self-Policing

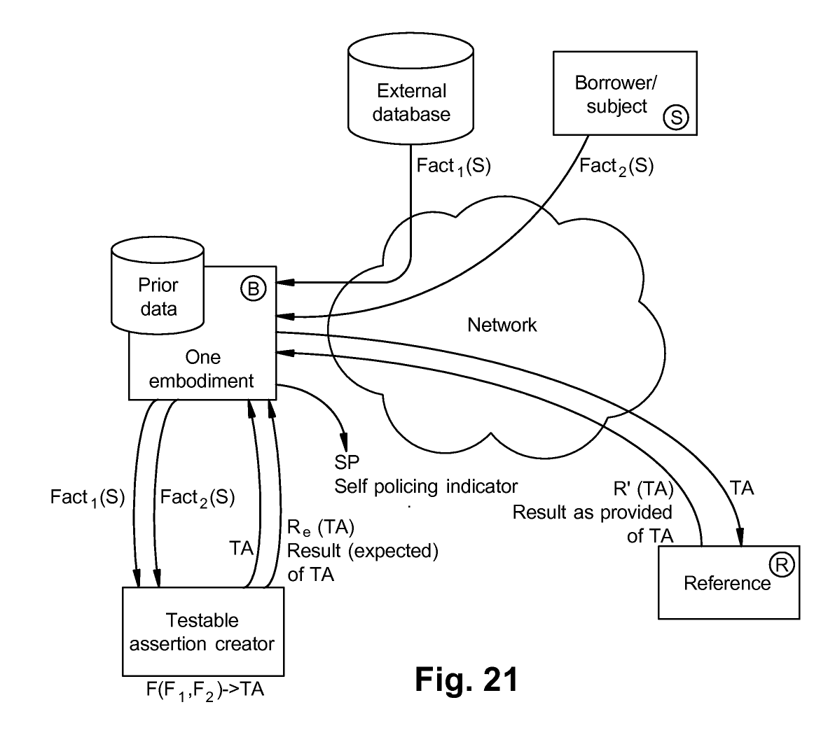

FIG. 21 illustrates one embodiment of a system that implements the use of input facts to create a testable assertion with an expected result.

A bureau B may be collating credit data about a subject S from various sources which are not completely trusted, including possibly because the source of the data is subject S itself (or just due to the fact that the world is a changeable and uncertain place). One or more relatively trusted facts may be isolated from amongst this data, each trusted fact comprising both a statement of fact and a relative level of trust.

A Testable Assertion Creator is shown, taking in a plurality of facts and returning a testable assertion with an expected result. A Testable Assertion Creator may be used to take in one or more trusted facts and create one or more testable assertions (TAs), which each comprise an assertion relating to S, and one or more expected responses or correlates, which may be a simple boolean (true/false). For example, a trusted fact that “subject S's warehouse has address 123 State Street, Chicago Ill.” may be provided to a Testable Assertion Creator, which may produce a testable assertion “subject S has a warehouse in Chicago (expected:true)”

The TA may be a single static piece of information about S (such as “number of years in business”), or it may be a hybrid TA that is wholly or partially derived from the information provided by S mixed in with externally derived database information about S. The TA may also be wholly or partially derived from information provided not by S itself.

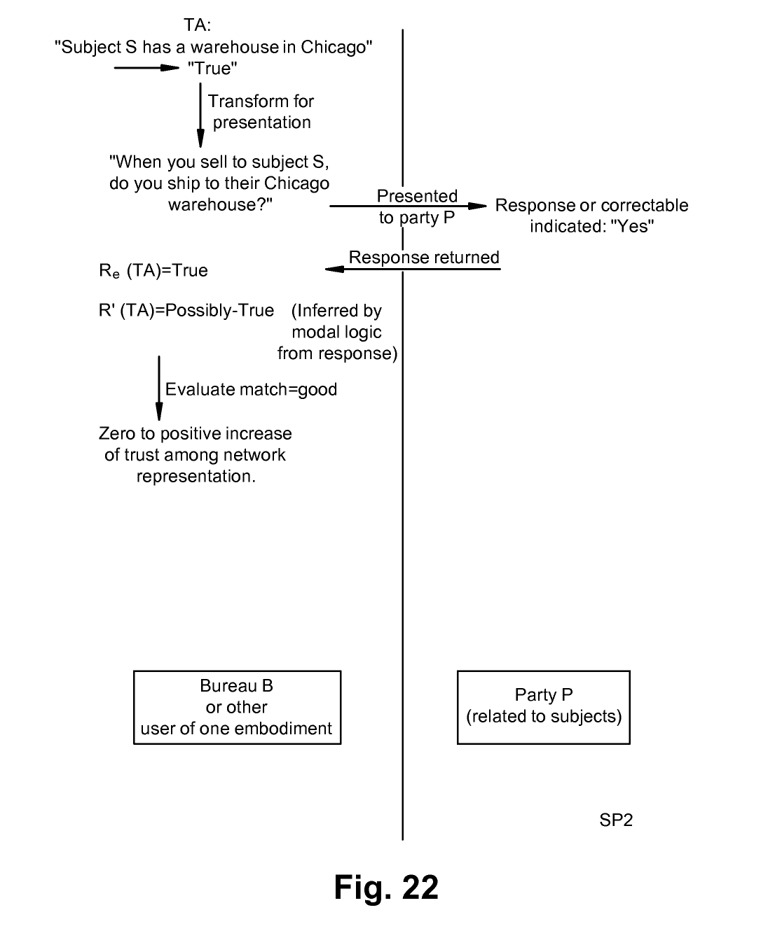

FIG. 22 illustrates an example of the back-and-forth flow between a user of one embodiment on the left, and a party P with an ostensible relationship to a subject S on the right, during which flow the TA is presented via a transformation, and a response is received which is evaluated using a modal logic. A means of communicating with a party P ostensibly having a business relationship with subject S may be used to present the testable assertion (TA) and to explicitly or implicitly prompt for a response or correlate. The TA may be transformed as part of this presentation for aesthetic or response-rate-boosting purposes, as may be the expected response value (as for example by the use of a modal logic which calculates whether a given assertion must be true, or might be true, or must be false, etc., according to a known state of the world). For example, a trade credit reference who is ostensibly a vendor to the subject S may be asked, “When you sell to subject S, do you ship to their warehouse in Chicago? (yes/no/I don't sell to subject S/they don't have a warehouse in Chicago)”.

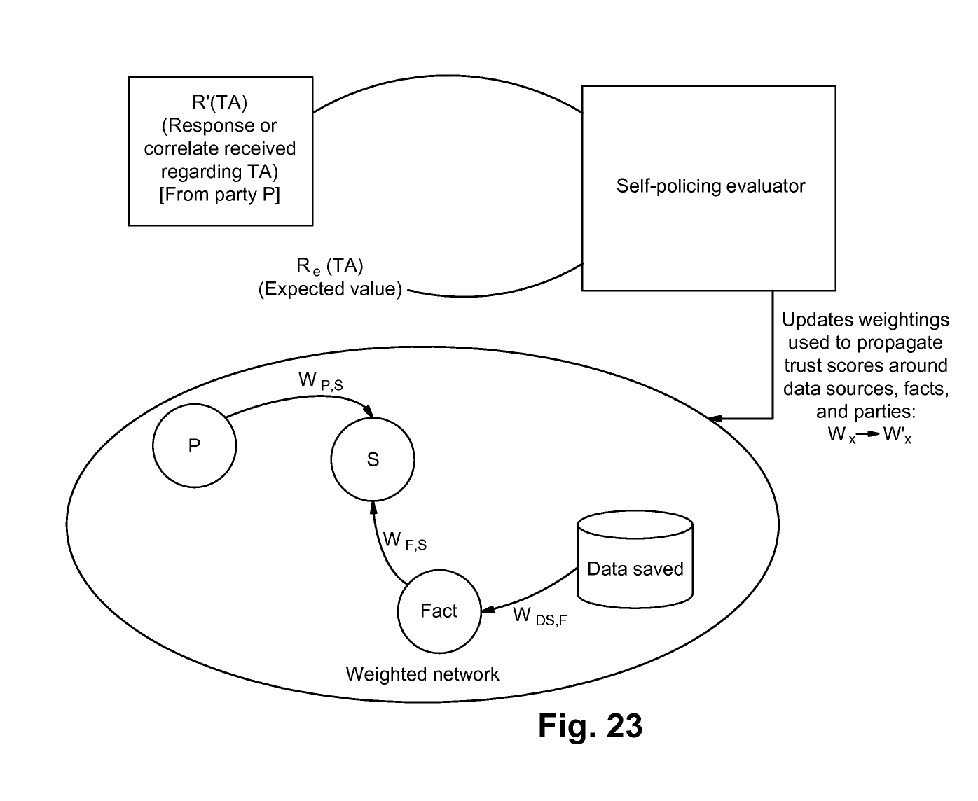

FIG. 23 illustrates an example of the use of the evaluation of a response and its expected value to update weightings among a network model of trust among participants and the ostensible facts pertaining to them. The response or correlate that is solicited from party P may be compared against the TA's expected value. If the response or correlate does not match the expected value, the effect may be to reduce the level of confidence imputed to one or more of: the input fact(s) or their source(s); the subject S; or the party P. This reduction in confidence may be effected by a numerical score associated with the outcome of the response comparison, which score may be propagated via a weighted network model to the associated nodes.

Two main benefits may result from self-policing (SP). When good guys interact with the SP process, they tend to increase our trust in the information that underlies the Testable Assertion. When bad guys interact with the SP process, they tend to reveal or incriminate themselves, because they give inconsistent answers, or otherwise behave in patterns that are detectable.

Traditional credit bureau methods involve centralizing information inputs, and comparing them for inconsistencies. Information flows in to a center, and is evaluated there. In SP, we automatically flow the information out to other parties in the process, and challenge them. A similar approach is used in “knowledge-based authentication” techniques (KBA) where a user is challenged with information he “should” know. But unlike in KBA, we don't pull information about a user and feed back to that same user; rather, we get information about a user and feed it forward to other users who have a putative relationship with that user, as a way of testing both the information and the relationship.

In the foregoing illustrative example, the asking of the email-contacted references at least one question that is based upon information provided by borrower David is an example of the presentation of a transformed Testable Assertion. The comparison of the answer to that question with the self-reported information from David is an example of a comparison to the expected response or correlate of a TA. The benefit provided is a higher measure of confidence in the coherency of the information being provided by references and borrower David to creditor Barry.

### Creditor Feedback

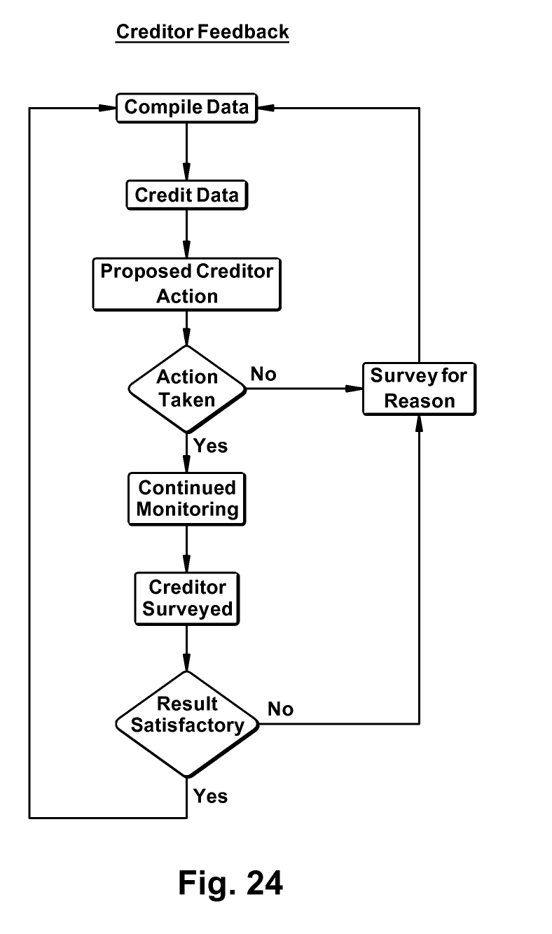

FIG. 24 shows an example flow chart of feedback from e creditor into a credit network.

In another example, subject business S and creditor business C may anticipate entering into a business transaction. Information about businesses S and C may be recorded before the transaction has been initiated. This could include the industry sector for each business, number of employees, legal registrations, time in business, financial characteristics and other characteristics about the businesses. Additionally, information regarding the transaction itself may be recorded. This may include the product or service involved in the transaction, the credit terms or other financial terms, or the means by which the transaction came about. This information may then be associated with businesses and the transaction both in a general and temporal context.

During the course of the anticipated transaction additional information may be collected. This may include whether one or both parties decide to proceed, or how each step of the transaction is proceeding whether regarding services, products or financial data. Again, this information may be associated with business S and C in a general and temporal context.

Creditor business C may be prompted to provide information from their perspective on how the overall transaction proceeded. This may involve whether business C decided to proceed with the transaction, whether the transaction occurred as expected, or whether transactions terms were adhered to, among other factual, objective information. Additional subjective information may also be gathered such as whether creditor business C may enter into a transaction with business S in the future or how the terms of a future transactions may be altered.

The set of this transaction information from creditor business C regarding a transaction with business S may then be used as feedback into a credit system. The information about the transaction may be taken into account to augment a credit data set on business S. Additionally, information about the creditor C may be used to adjust the credit data set and its application to the business S. For example a creditor business C that present little business characteristics information and has provided feedback on only a single transaction may yield transaction data that has little weight in the feedback of credit data to business S, whereas a creditor business C that has provided extensive information regarding the characteristics of the business along with numerous transaction data sets may yield a transaction data set that is highly weighted and may cause appreciable variability in the credit data of business S.

The collection of this information from creditor businesses and the subject businesses may be used as a more granular means to collect credit data and provide faster feedback into a credit data system. This collection also allows comparison of the expectations with both creditor C and business S before, during and after the transaction has occurred. This information may be used to further provide data regarding transactions businesses C and S should enter into in the future and the terms of those transactions.

Current practices by credit bureaus do take into account a “feedback” mechanism from creditors, but it is highly indirect and imprecise. Specifically, the use of recording “credit inquiries” as meaningful signals about a credit report is common practice (this practice transforms the act of reading a credit report into effectively writing upon the report, since the recordation of the inquiry affects the report in future). Historically this feedback has been limited to recording a “hard” vs. “soft” inquiry (hard inquiries being those for active credit determination, soft being for other purposes) and date of each such inquiry. In one embodiment of the present invention, a much richer variety of information can be fed back into the system, including information not merely about the fact or intent of the inquiry, but the extent to which the parties themselves did or did not proceed, and how any anticipated transaction turned out. Presently, a single “hard” inquiry on a report is considered slightly derogatory due to its correlation with certain negative outcomes. But that “hard” inquiry in fact could be indicative of either an unhealthy need, where a borrower is “scrambling” for credit, or, of a very healthy use of credit, where a borrower is responsibly expanding its business operations. One embodiment of the present invention may permit discrimination between unhealthy and healthy expansions of credit.

In the foregoing illustrative example, the notation by Barry's credit function that they decided to extend a $5,000 credit limit to David is an example of the receipt of feedback, and the future update into the system for purposes of monitoring and alerting is an example of the use of such feedback.

### Electronic Pull-Based Pre-Contacted Credit References

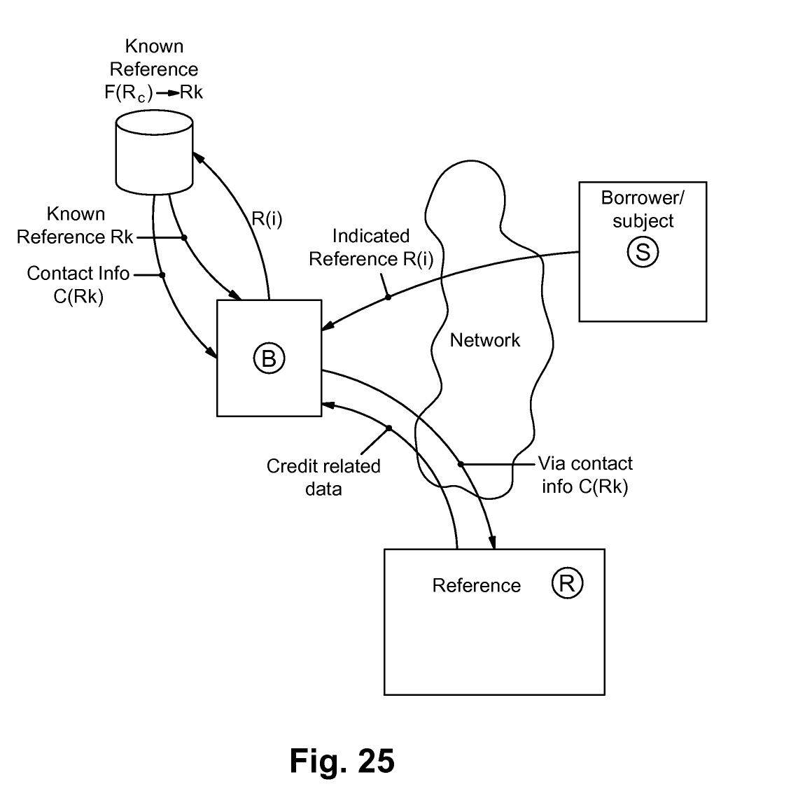

FIG. 25 illustrates an example workflow of identifying and mapping a credit reference and retrieving known contact information. A subject S may indicate a credit reference R(i) to a bureau B. B may map the indicated reference R(i) to a known reference R(k), which may be associated with known contact info C(Rk). B then may contact R(k), or B may avoid the necessity of contacting R(k) because of prior knowledge or belief that R(k) cannot or will not respond, or B may refer instead of a pre-existing data contribution from R(k). Because the contact means for R(k) was developed by B independently from the indication by S, B may have a higher degree of confidence in the legitimacy of the credit reference and in the data provided, than might have been the case if B had contacted reference R(i) using contact information provided by S.

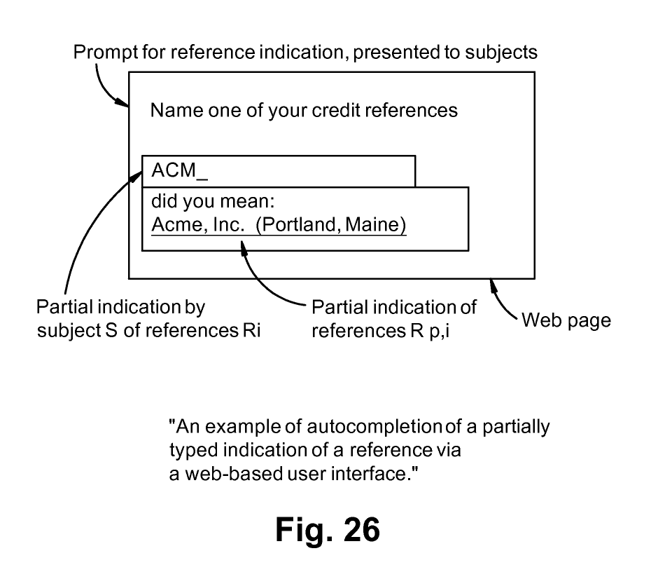

FIG. 26 is an example Web user interface auto-completing the identification of a credit reference. A subject S may be prompted by B with one or more prompted indication of a credit reference R(p,i) based upon information about S. If subject S indicates that R(p,i) is a suitable reference, R(p,i) may be mapped to R(i) in the above description. The prompting of with R(p,i) may be based upon industry, geography, size, or other prior knowledge about S. The prompting of S with R(p,i) may be informed by partial indication of R(i) by S, for example in the case of autocompletion of a partially typed indication. The prompting of S with R(p,i) may be informed by prior indicated references by S or by other prior subjects with characteristics similar to S.

Subjects who not only indicate the name or identity of a credit reference but who also provide contact information for that reference may be legitimate, but they may also be fraudsters seeking to direct the bureau or creditor to a collusive or fraudulent reference. For example, a fraudster may indicate that Acme Inc, is a vendor reference, and indicate that they may be contacted at phone number 123-456-7890; even if Acme Inc, is a legitimate company, the phone number provided may be a number for a confederate who will falsely indicate excellent trade history for the fraudster. In one manifestation, the present invention may help prevent this type of fraud.

Sometimes, subjects may not have sufficient numbers of references at “top-of-mind” to be able quickly and easily to recall them. This can lead to lower rates of indicating references, which in turn can lead to lower numbers of completed reference responses, and a lower likelihood of completing a satisfactory and useful credit report. By prompting subjects with likely, possible, or preferable references, a credit report can be created with greater likelihood and in less time with one manifestation of the present invention.

In the foregoing illustrative example, the auto-completion of the name of Eschew Ergot Ryeberries Inc, (EER) is an example of the mapping of an indicated reference to a prompted, indicated reference. The benefit is that the contact channel to EER may be considered more secure because it uses externally-derived contact information, rather than contact information presented by a possibly-fraudulent subject borrower.

### Subject-Controlled Privacy in Commercial Credit (SCPCC)

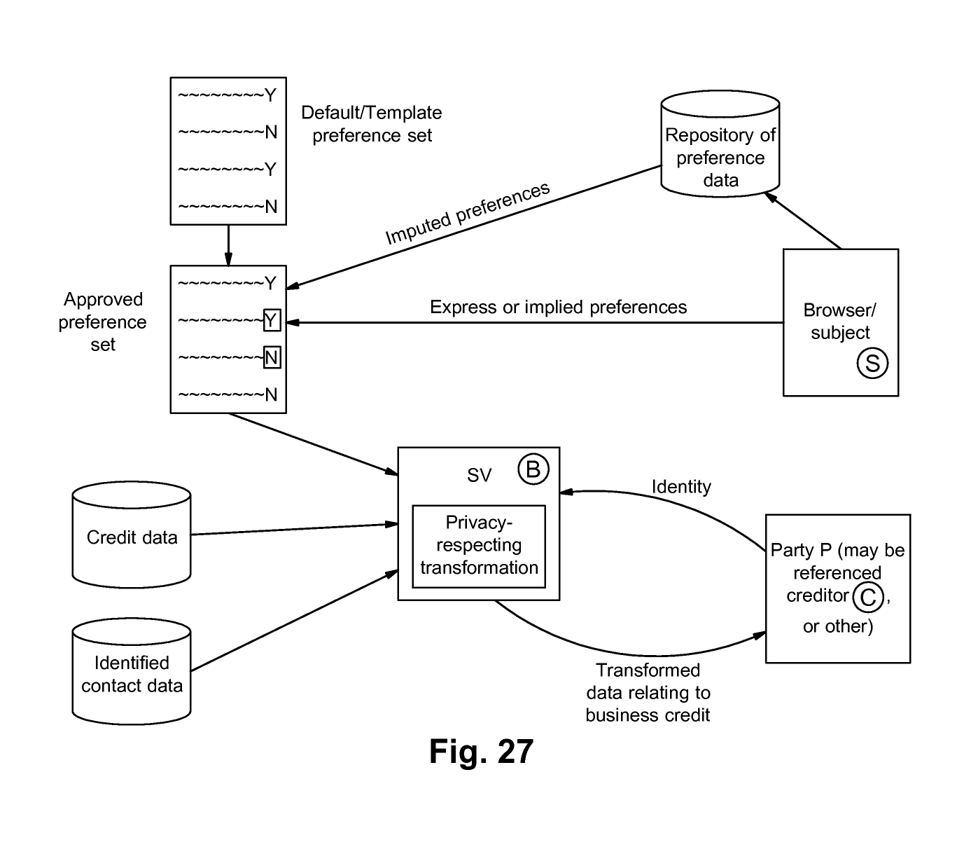

FIG. 27 illustrates one embodiment of the creation and application of a preference set in order to effect a privacy-respecting transformation of credit data. A set of preferences may be applied to credit information and processes regarding subject S, including a default set, which may specify which elements of the identities and credit experiences of related parties may be revealed about each such party to other parties. Related parties here may include creditors C and references R, who participate in the formation of a report on subject S, and other parties may include those related parties or other parties who seek credit information about subject S.

A set of preferences may be applied to credit information and processes regarding subject S, including a default set, which may specify the granularity or specificity of credit or trade data which may be revealed from the credit information about subject S. Such preferences may be applied to individual actors as in the use of an access-control list (ACL). Such preferences may be applied to categories of parties defined by their relationship to subject S.

A set of preferences containing one or more pricing formulae may be applied in conjunction with another set of preferences regarding credit information about subject 5, which pricing formulae indicate the “asking price” at which the subject S is willing to accept monetary payment or other measurable compensation for overriding otherwise-prevalent preferences regarding the privacy of its credit information.

A privacy-respecting transformation may be effected based upon the interpretation of one or more sets of preferences regarding credit information about S, and may be applied to credit data and other data about S which is to be delivered or assembled into a credit report or may be applied to an already-assembled credit report about S. A privacy-respecting transformation may also be based upon the identity of the party requesting credit data or a credit report about S, and an indication of the monetary amount or other measurable compensation offered as a “bid price.” A privacy-respecting transformation may encompass the use of mathematical measures of uncertainty or entropy, such as in the application of the technique of k-anonymization.

Subject S may or may not want reference R to know that S is seeking credit terms from creditor C, because this could affect the relationship of S and R (for example, S may want stealthily to “fire” R, or S may want to create negotiating leverage versus R). The ability of S to control this increases the likelihood that S participates willingly and fully in creating the credit report, and creates a sense of transparency and control which builds goodwill with S.

Both direct (C calls R) or indirect (B calls R) current methods of credit reference checking tend to leave S without knowledge of or control over whether some parties' identity and contact information are “leaked” to other parties. S must merely hope that C or B will conduct the reference without causing adverse effects, which tends to decrease the likelihood of S participating willingly and fully.

In the foregoing illustrative example, the choice of David's AP manager to provide credit reference information is positively influenced by her perception that she has control over the privacy preferences that will be applied to information collected about David's business.

### Incentive Per-Action (IPA)

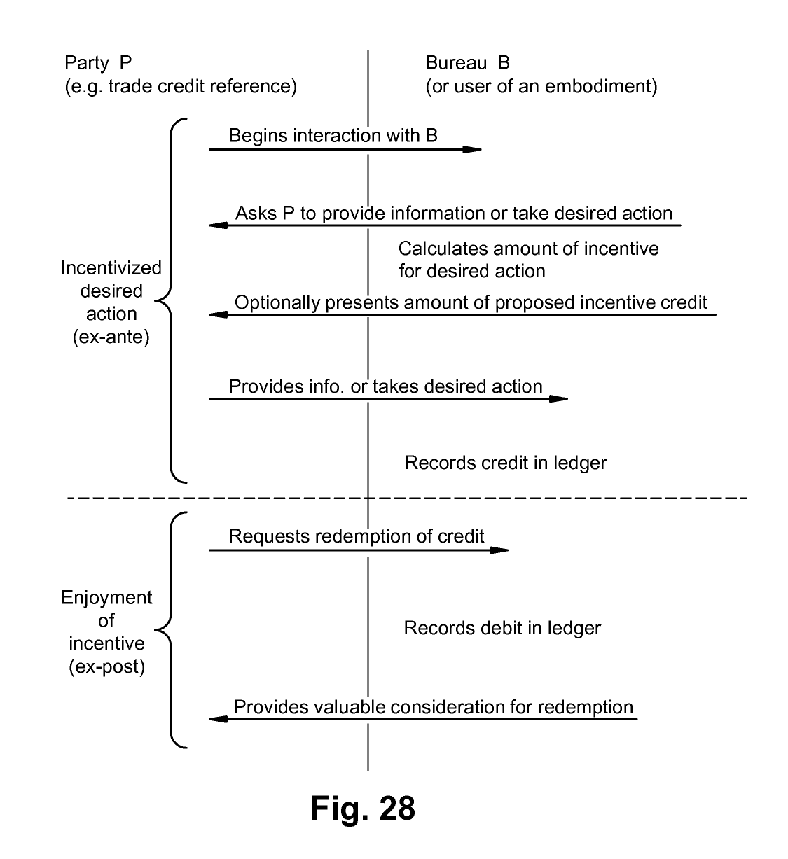

FIG. 28 illustrates an example of the flow of actions between a party and a bureau in order to reward a desired action with a credit, and to redeem the credit. Information about trade experiences or other credit-related data on one or more subjects S may be received from a party P. The receipt of that information may constitute a “desired action” by party P (here for clarity only, we note that the “desire” for the action is from the perspective of the recipient). The event of a desired action may according to a set of rules which may be varied based upon the identities and preferences of party P and/or subject S, cause a credit of some amount to be entered upon a ledger. Those credits may be debited by party P in order to offset otherwise incurred charges, or may possibly be redeemed in some other fashion (e.g. cash). More credits may be earned by more individual actions. The existence of the incentive credit and the amount of the credit may be revealed to a party P prior to the conclusion of the desired action, in order to make explicit an incentive or motivation for P.

A ledger used in creating incentive credits may be of a double-entry accounting type, or it may be of a single-entry accounting type, or it may be a single, overwritten buffer; accordingly, the entry of contra debits against the incentive credits may take the form of a proper ledger entry or the update of a single, overwritten buffer, among any other acceptable means of recording the current credit balance in an embodiment.

Currently, credit bureaus find it uneconomical to acquire data on a small scale; every bit of trade history or reference data must be imported, assembled, linked to an existing record, and potentially verified. Hence, the economic incentives that are provided to references R are coarse-grained; typically, the incentive is a broad discount (e.g. 50% off of list price) in return for a broad commitment (upload your entire AR aging report for all customers every month). Because of aspects of certain embodiments of the present invention, as well as other innovations by the inventors, we may find a economical to acquire data at a much smaller scale. Hence, one embodiment of the present invention allows us to provide incentive for even a very modest contribution of data, to recognize that contribution, and to encourage incremental contributions.

In the foregoing illustrative example, the receipt of a credit as a “thank-you” incentive by one of the references who at other times acts as a creditor, is an example of crediting a ledger based upon a desired action regarding trade experiences. The benefit is that the reference/creditor user who receives that incentive credit is made more likely to continue using the system (and hence contributing data), as well as is made more likely to contribute reference data subsequently due to the well-known behavioral effect of “random reward” conditioning.

### Age Support & Event Cluster Flagging (ASECF)

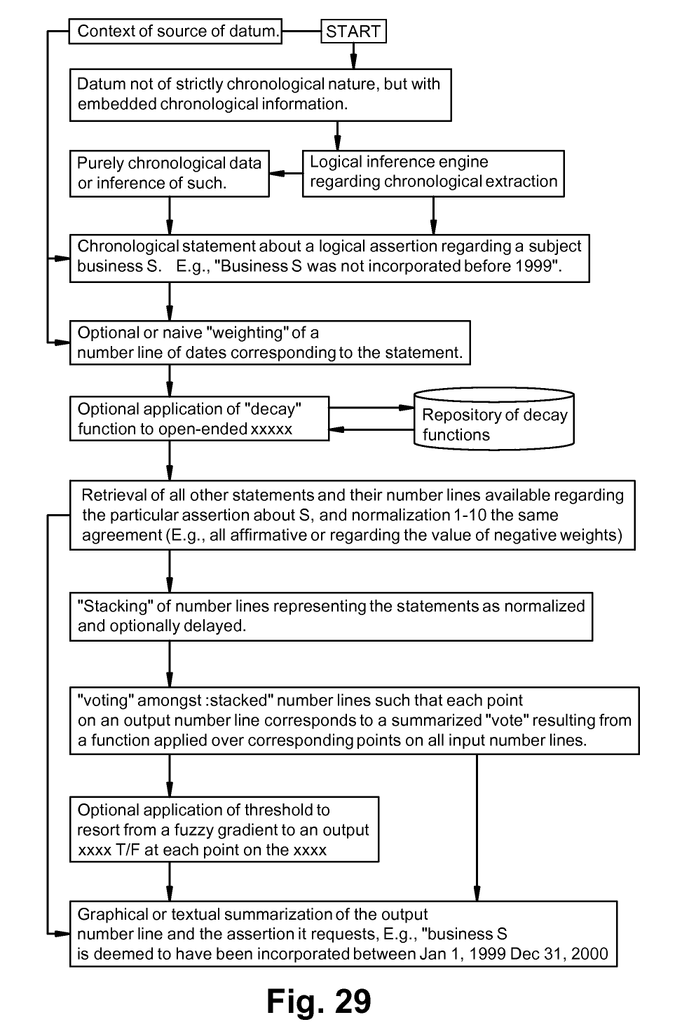

FIG. 29 illustrates an example of a workflow for processing chronologically-applicable data into a summarization of a chronological trust statement. An input data set of chronologically-applicable data, each of which either contains or can be processed by a supporting heuristic to produce one or more of: 1. an inequality about dates as applied to a logical assertion pertaining to subject business S, or 2, an imputed event moment pertaining to subject business S may be obtained. These may include information, including information from or about putative trading partners of S who serve as references; information about technical, legal, financial or similar registries or transactions; or self-supplied information from S.

Date inequalities or event moments may be transformed into constraints which may be processed by a well-known constraint-processing system such as a linear programming system. Date inequalities or event moments may also be transformed into points on a number line, which may be truncated to a window representing dates of realistic interest to the parties evaluating the input data set. Date inequalities or event moments may also be transformed by decay functions which may be an attempt to represent the ambiguity, incompleteness, relevance, or relative trustworthiness of the input data. For example, to learn of a contemporary business S that “S was incorporated before 2001” does not mean that the incorporation was equally likely to have occurred in 1999, 1979, 1812, 1066, or 315 BC; therefore, a decay function may be applied which causes the relative weight of the statement to be only slightly applied with respect to dates which, like 1812, 1066, or 315 B.C., are very unlikely to represent the date of a relevant event in a corpus of business credit data. Here we will continue to use the term “date inequalities” to refer to any of a proper inequality; an event moment; a system of constraints; or a series of points on a number line, so long as they represent putative knowledge about dates from the input data set,

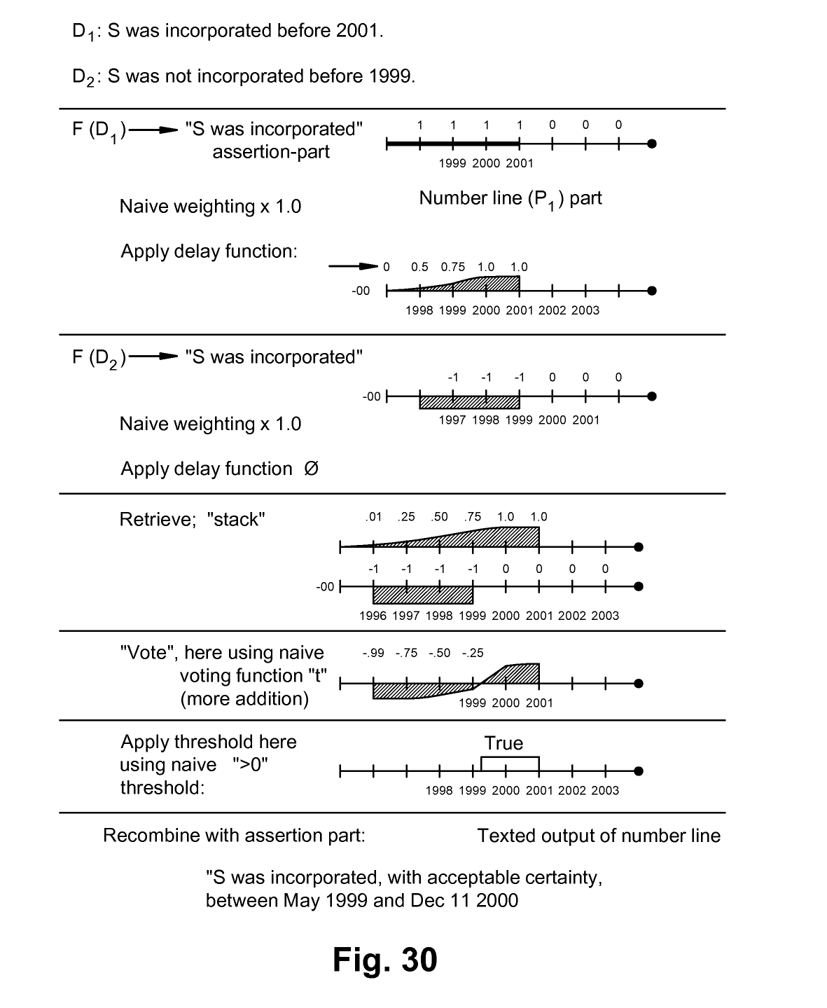

FIG. 30 illustrates one or more examples of graphically and numerically using a number line “stacking” to “vote” among the date inequalities. The date inequalities as applied to logical assertions may be combined according to an adjustable formula in order to, in two non-limiting examples, (1) “vote” among the date inequalities such that a threshold proportion (e.g. a 75% supermajority) all “agree” that a particular inequality holds (e.g. the business is at least 5 years old); and (2) “cluster” events which have a logical relation to one another, and whose relative proximity in time has known or to-be-discovered relevance.

In one example, an “age support” indication may be obtained, which summarizes the amount of support that a particular chronological statement has within the entire set of data. The age support indication may include a visual representation where elements representing the inequalities are “stacked” (including stacking represented without a Z-axis by adjustment of opacity) in a way that reveals the depth of support within the data Second, “cluster flags” which indicate that events with some logical relation may be clustered in time, and which clustering may be relevant. Clustering techniques such as the well-known K-means clustering or nearest-neighbor clustering may be used.

Traditional business information providers attempt to provide chronological information, such as years in business, either as a single scalar (date or age) or a category/range (e.g. 5-7 years). The age support indication allows a fuller assessment of the type of data that a bureau can collect, while making sense of the (almost inevitable) contradictions and inconsistencies that arise when collecting a lot of data. The clustering of events is a crucial element for detection of fraud or default risk, but is currently ill-served and conducted by “eyeball,” For example, if a business claims to be 10 years old, but its phone, website, and corporate form all seem to have been registered in the last 4-5 months, that may be a cluster that indicates fraudulent misrepresentation.

In the foregoing illustrative example, the indication on David's credit report of a cluster of dates 3.5 years ago is the product of one embodiment. The benefit here is the automatic summarization of a large variety of chronologically-applicable data and the relative harmony with the self-characterized age from David of 4.0 years, which helps make David's credit profile more complete and trustworthy.

### Honeypot Credit Inquiry Sensor (HCIS)

A series of sensor or honeypot network endpoints (e.g. Web pages) may be deployed, with one or more endpoints per business credit subject S. Honeypot describes the function of the network endpoint in attracting or inducing curious or inquisitive parties to interact with the endpoint. Network endpoint may include for example a Web page served over HTTP protocol, or it may include a telephone number, or it may include a document made available via a sharing mechanism such as Sharepoint, provided that the network endpoint may be monitored in order to detect the interaction of a curious or inquisitive party with the endpoint. For example, an Apache web server's log may be monitored to observe if a particular document D has been requested, and if so, how often and from where, and that document D has the function of attracting or inducing curious or inquisitive parties to interact with the document D, for example by using a Web search engine with search query terms that are prominently present in document a Content and metadata on the endpoints may be deployed so as to optimize (e.g. Search Engine Optimization) each endpoint to attract queries regarding its subject S in the context of providing business credit information (alternatively, if request metadata may provide indication that its context is business credit-related, the need for credit context on the endpoint itself may be obviated). No active measures to induce traffic to the network endpoints need be taken. Any network requests to the sensor endpoints may be logged and analyzed (including if necessary weighting or filtering to attempt to capture bona-fide, human-initiated business credit-oriented inquiries). Other weighting techniques may be applied including weighting for common or ambiguous names, for large vs. small subject businesses, etc.

A result may be a timestamped record of virtual “credit inquiries” about a business, which record can be used in a credit report or score as a proxy for traditional forms of credit inquiries.

Traditional credit bureaus record inquiries, such as when a credit report on a subject is sold to a potential creditor, and use the presence and timing of inquiries as part of the report and/or score that they sell to subsequent creditors. The ability to use this inquiry-based feedback loop is the province of incumbents who possess not only many records, but sufficient market share among customers that they are likely to receive a useful proportion of the “true” inquiries about a subject in the market. Since, today, many people attempt to use a search engine like Google to seek an information product before going through traditional channels, they may search Google for “Acme Inc. credit report” before going to D&B to purchase such a report. If the system can log a network request to an “Acme Inc, credit report” endpoint, it gets the benefit of learning of an inquiry without necessarily having sold a credit report to the inquirer (or indeed, without necessarily even having such a report),

### Creditor Feedback and Network Representation

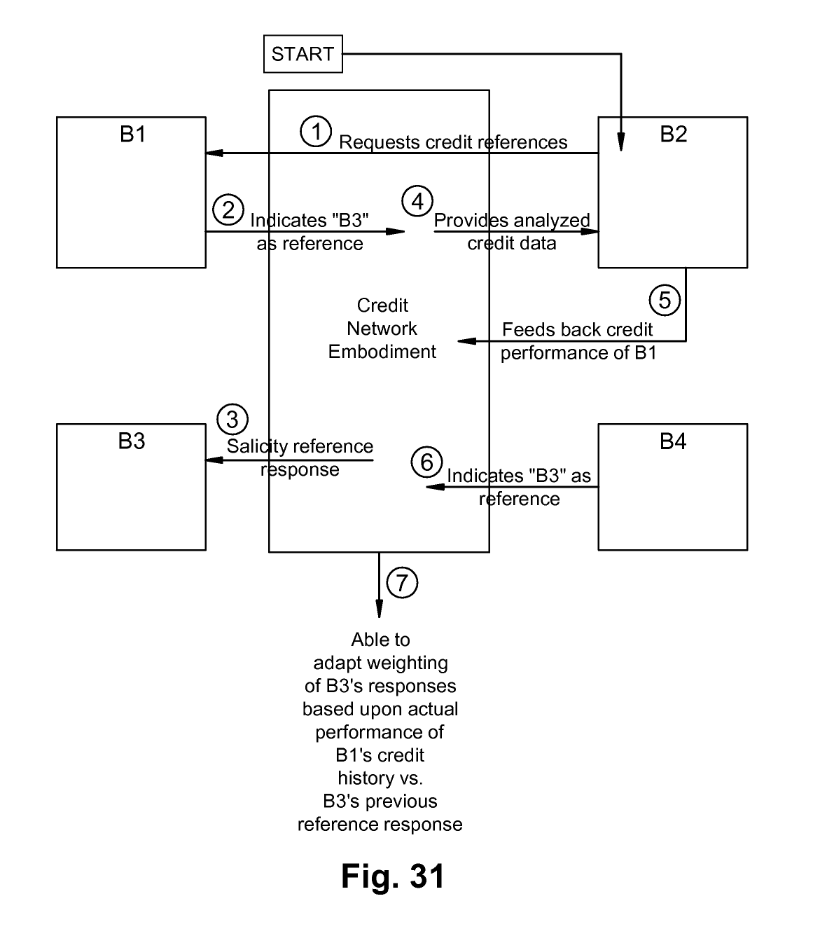

FIG. 31 illustrates one embodiment of a process enabled by the network representation where a business has multiple roles and by the credit feedback process to transform the interpretation of credit reference responses according to an observed performance measure. B1 may indicate that B3 is a reference, and B3 may provide credit information about B1 via the embodiment, B2 may become an actual creditor of B1, and may thereby observe B1's payment behavior and may provide it via the embodiment, B4 may later also indicate that B3 is a reference, and B3 may provide credit information about B4 via the embodiment. The credit information provided about B4 by B3 may be transformed so as to reflect the concurrence or lack thereof between the original information provided about B1 by B3, and the observed payment behavior of B1 by B2. For example, if B3 had given B1 a glowingly positive reference but B2 observed that B1 performed poorly, the relative weighting of B3's reference for B4 could be diminished accordingly.

Traditional credit reference processes may be too sparse to have a high likelihood of enjoying the repetition of a business as a reference multiple times. The use of a credit network along with creditor feedback to dramatically increase the likelihood of enjoying the repetition of a business as a reference or in other roles and thereby to project a measure of its reliability and use such measure to transform conclusions about credit information depending in some way on its reliability is described.

### Subject Controlled Privacy and Token Based Provisioning

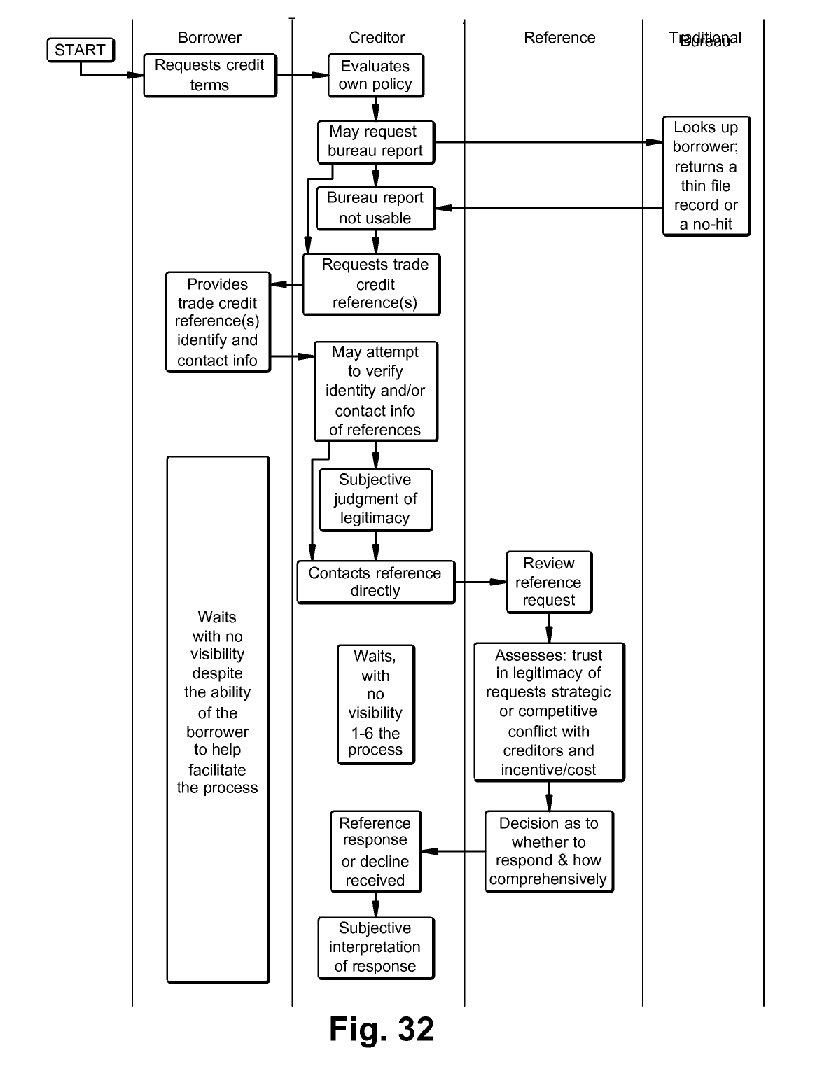

FIG. 32 illustrates an example workflow of checking trade credit references in the absence of an embodiment of the present invention. The creditor is directly provided with the identities and contact info of the putative reference by the borrower, and the creditor then undertakes to contact the reference directly. During the time that the borrower is waiting for the creditor to complete its reference checking, the borrower has no visibility into the status of the process; likewise, during the time that the creditor is waiting for the borrower to possibly respond, the creditor has no visibility into the status of the process. Furthermore, the putative reference may be fraudulent, or may a collusive confederate of the borrower, and the creditor's subjective judgment of the legitimacy of the reference and its relationship to the borrower is the creditor's main protection against fraud or collusion,

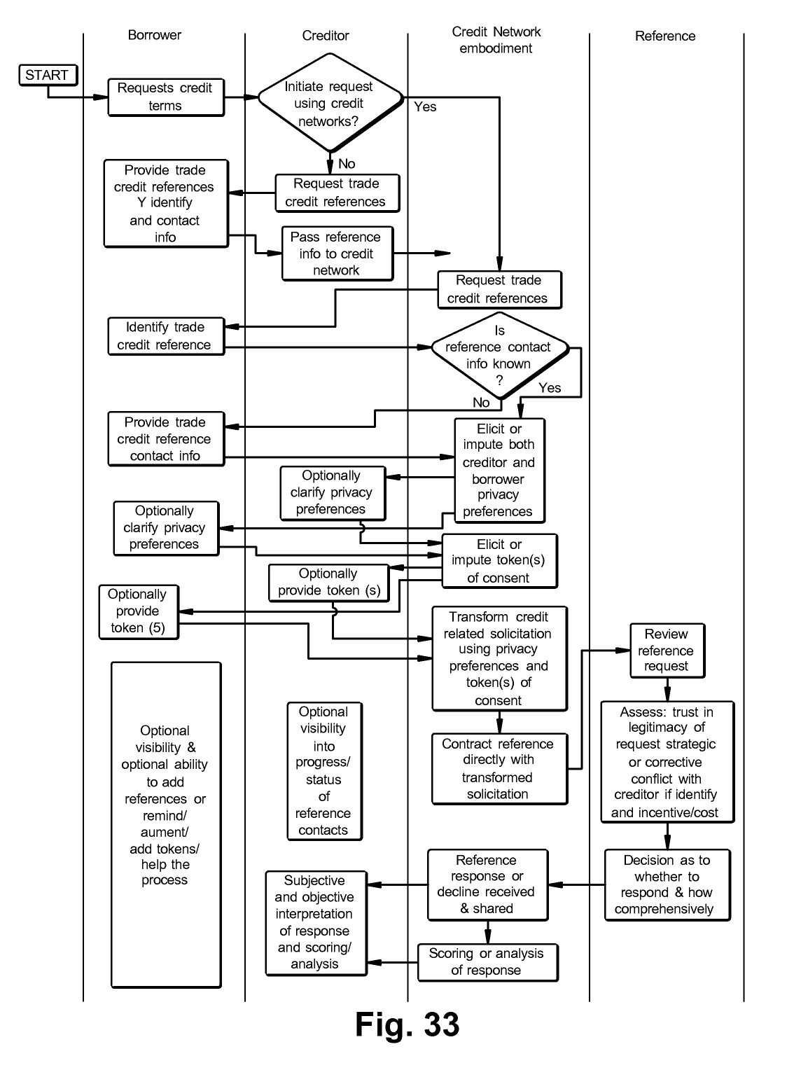

FIG. 33 illustrates an example workflow of checking trade credit references using an embodiment providing subject-controlled privacy in commercial credit, token based provisioning, and electronic pull-based pre-contacted credit references, in contrast to the previous figure. The borrower may have the opportunity to view and clarify its privacy preferences, which may afford a higher confidence in the probity of the process and induce a higher likelihood of providing additional, useful information of a possibly sensitive or private nature. The reference may be shown a solicitation for credit information which has been transformed by one or more privacy preferences and/or tokens. The details of the creditor may not be shown to the reference, and/or the details of the reference may not be shown to the reference, according to the privacy preferences, which may avoid inducing in the reference a hesitation to provide credit information which could give rise to a competitive situation, such as if widget seller #1 is a creditor and widget seller #2 is a reference and widget seller #2 is willing to serve, as a reference for the borrower but is unwilling to reveal details of its trade terms directly to a known competitor in widget seller #1. The presence of a solicitation for credit information which has been transformed by inclusion of a token or a transformation of a token may induce a reference to have a higher level of trust in the probity of the process and induce a higher likelihood of providing additional, useful information of a possibly sensitive or private nature. The role of the network in intermediating tokens and checking identity and contact information provides some protection against undetected fraud or collusion beyond what the creditor might enjoy in the previous figure.

Current practice often results in potential references having hesitation, including hesitation codified in company policies, about providing possibly sensitive credit information. A combination of the use of privacy preferences and token based provisioning to assuage these hesitations and induce greater participation is described,

### GENERALLY

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. a method, comprising:
sending a request for credit information to a plurality of references, the request for credit information including a subject business identifier and questions regarding transactions between the reference and the subject business;
receiving at a receiving system the requested credit information from one or more references;
storing the credit information in a credit information database;
in response to receiving a query from at least one user regarding the creditworthiness of the subject business, searching the credit information database for matching credit information of the subject business;
evaluating the snatching credit information to determine a credit score;
outputting the credit score and subject business identifier; and
presenting on a presentation device the matching credit score and subject business identifier to the one or more users.
